(19) United States
(12) Patent Application Publication
(10) Pub. No.: US 2004/0064698 A1
(43) Pub. Date: Apr. 1, 2004

(54) Electronic seal, memory medium, advanced authentication system, mobile device, and vehicle start control apparatus

(76) Inventor: Xiaomang Zhang, Tenri-shi (JP)

Correspondence Address: BIRCH STEWART KOLASCH & BIRCH, PO BOX 747, FALLS CHURCH, VA, 22040-0747, US

(21) Appl. No.: 10/673,847

(22) Filed: Sep. 30, 2003

(30) Foreign Application Priority Data
Oct. 1, 2002 (JP) 2002-289228

(51) Int. Cl. H04L 9/00

(52) U.S. Cl. 713/169

(57) ABSTRACT

An electronic seal includes an input/output section for receiving a random number encrypted based on a prescribed key; and an advance authentication processing section for decrypting the encrypted and received random number based on a secret key related to the prescribed key and then encrypting the decrypted random number based on the secret key. The input/output section outputs the encrypted random number encrypted based on the secret key.

### BACKGROUND OF THE INVENTION

1. Field of the Invention

The present invention relates to an electronic seal, and memory mediums such as, for example, an IC card and a memory card used for, for example, over-the-counter services at municipal offices and in electronic commerce for authentication; an advance authentication system using the same; and a mobile device, a cellular phone device, and a vehicle start control apparatus accommodating the same.

2. Description of the Related Art

Conventionally, authentication is performed for over-the-counter services at municipal offices and commercial transactions using a seal (traditional seal). When a seal is stolen, or lost for some other reason, the user can easily notice such loss and can prepare countermeasures against any possible damage.

Recently, information in the form of electronic data (digital data) has been used in, for example, IC cards, ID cards, electronic commerce and encrypted electronic mail. This causes methods of authentication to be changed.

IC cards, ID cards, electronic commerce and encrypted electronic mail ideally have a very high security level, but in actuality, a very low level of security means is used such as, for example, a four-digit password.

For example, IC cards used as electronic wallets (also referred to as “smart cards”) are available as credit cards or cash cards. When a credit card is used, authentication is performed by two factors of (i) security check by the IC card and (ii) visual confirmation of the signature. When a cash card is used, authentication is performed by two factors of (i) security check by the IC card and (ii) confirmation of input of the password.

However, it is not easy to visually identify a false signature, and a four-digit password has a low security level. An increase in number of digits for improving the security level puts a burden on the user.

The security level of an IC card can be increased by performing authentication based on the user's inherent information, for example, signature, fingerprint, voiceprint, retina pattern, and face. However, in consideration of the software aspect such as the algorithm, hardware aspect such as the apparatus, and management aspect such as operation by the user, it is not easy to actually use such a method of authentication.

Mainly in the U.S. and Europe, IC cards are used for billing cellular phones, cable TV services, and the like. The security is checked using a PIN provided to the user. This also has the same security problem as the password.

ID cards used for entering and exiting from a building or a room are widely used. However, an ID card is the only means for authentication and therefore can be easily abused when stolen or lost.

The security level of electronic commerce relies on a special web browser, which has a certificate which has been issued by an authority. A password is required to use the special web browser, but once the password leaks, anybody can access the special web browser regardless of the security level in the special web browser.

Regarding encrypted electronic mail, keys for encryption and the like are managed by a computer. Therefore, anybody who uses the computer can freely read or write mail.

FIG. 13 is a block diagram illustrating an example of a conventional authentication system.

Referring to FIG. 13, an authentication system 110 includes a remote server 111 for storing card-related contents as backup; an IC card 112 having information which is related to communication with a host computer 113 (described below), security processing information and password checking information stored thereon; the host computer 113 for performing various types of processing, for example, service type display processing, selection execution processing, security processing, and password input processing; a card reader/writer 114 for acting as a communication interface between the IC card 112 and the host computer 113 or for supplying power to the IC card 112 by electromagnetic induction when the IC card 112 is of a non-contact type; and an input device 115 for inputting a password or the like. The authentication system 110 performs authentication when an IC card is used as a cash card.

The remote server 111 has information regarding the IC card 112 stored thereon as backup. In order to access the remote server 111, real-time communication is required. Therefore, authentication is performed between the IC card 112 and the host computer 113, and between the user and the host computer 113.

The IC card 112 and the host computer 113 have a security function. Where the IC card 112 is of a contact type, data communication is performed for mutual security checks between the IC card 112 and the host computer 113 via the card reader/writer 114 acting as an interface.

Where the IC card 112 is of a non-contact type, power is supplied from the card reader/writer 114 to the IC card 112 by electromagnetic induction, and data communication is performed for mutual security checks between the IC card 112 and the host computer 113.

When the host computer 113 confirms that the IC card 112 is authentic, a password input screen is displayed on a display of the host computer 113.

Next, when the user inputs a prescribed password via an input device 115, the password is supplied to the IC card 112 via the host computer 113 and the card reader/writer 114. The password is checked inside the IC card 112. When the authenticity of the user is confirmed as a result of the checking, the user is allowed to use the IC card 112. Services are then displayed on a display of the host computer 113. When a type of service is selected by the user, the service is executed by the host computer 113 (see, for example, Japanese Laid-Open Publication No. 3-92966 “Electronic Wallet System”).

FIGS. 14 and 15 show a mechanism disclosed by the present inventors in Japanese Application No. 2002-225590 filed on Aug. 2, 2002 for using an electronic seal for authentication of an IC card.

FIG. 14 is a block diagram showing a part of one example of the authentication system disclosed by the present inventors in the above-identified application.

Referring to FIG. 14, an authentication system 200 includes a remote server 211, a card 212 such as, for example, an IC card or a memory card, a host computer 213, a card reader/writer 214, an input device 215 for inputting a password or the like, and an electronic seal 216. When the card 212 is used as a cash card, the electronic seal 216 is used for authentication.

The remote server 211 stores information on the card 212 as backup. In order to access the remote server 211, real-time communication is necessary. Therefore, authentication is performed between the host computer 213 and the card 212 and between the host computer 213 and the electronic seal 216.

First, mutual security check is performed between the IC card 212 and the host computer 213. After both are confirmed to be authentic, the user inputs a password via the input device 215. The password is sent to the IC card 212 through the card reader/writer 214 and checked inside the IC card 212.

Then, the host computer 213 outputs an information access request for payment to the IC card 212 through the card reader/writer 214. Before complying with the information access request from the host computer 213, the IC card 212 exchange information with the electronic seal 216 to perform authentication, namely, to check if the user of the electronic seal 216 is authentic. When the user of the electronic seal 216 is confirmed to be authentic, the IC card 212 accepts the information access request from the host computer 213. When the user of the electronic seal 216 is not confirmed to be authentic, the IC card 212 rejects the information access request from the host computer 213.

FIG. 15 is a flowchart illustrating the processing which is performed between the IC card 212 and the electronic seal 216 in the authentication system 200 shown in FIG. 14 for performing authentication using the electronic seal 216.

In step S301, the IC card 212 generates random number D1.

In step S302, random number D1 and a response request ID are encrypted based on a public key Kp. The encrypted random number D1 and the encrypted response request ID are sent to the electronic seal 216 together with a card company ID.

In step S303, the electronic seal 216 specifies a secret key Ks from the card company ID.

In step S304, the encrypted random number D1 and the encrypted response request ID are decrypted based on the secret key Ks specified in step S303. Thus, the decrypted response request and random number D2 are obtained. Random number D2 is the decrypted random number D1.

In step S305, it is determined whether an appropriate response request ID is included or not. When no appropriate response request ID is determined to be included, the processing is terminated in step S306. When an appropriate response request ID is determined to be included, random number D2 is encrypted based on the secret key Ks specified in step S303, and the encrypted random number D2 is sent to the IC card 212 in step S307.

In step S308, the IC card 212 decrypts the encrypted random number D2 based on the public key Kp to obtain random number D3. In step S309, random number D1 generated in step S301 and random number D3 obtained in step S308 are compared with each other. When random number D1 and random number D3 match each other as a result of the comparison, the user is confirmed to be the authentic user in step S310. When random number D1 and random number D3 do not match each other as a result of the comparison, the user is not confirmed to be the authentic user in step S311.

The authentication system 200 has the following problems.

The authentication system 200 indispensably requires the three elements of the IC card 212, the electronic seal 216, and the host computer 213 connected to the remote server 211 for authentication.

Namely, each time the IC card 212 is used, the electronic seal 216 is used. When the electronic seal 216 and the card reader/writer 214 are communicable with each other even over a long distance (for example, 1 meter or longer), authentication is not influenced even if the electronic seal 216 is not provided to the store clerk together with the IC card 212. However, the communicable distance is usually within 70 cm even in a non-contact communication system due to the restrictions by the Radio Law and for energy savings. When the IC card 212 is used as a credit card, the electronic seal 216 needs to be provided to the store clerk together with the IC card 212 in order to guarantee the communication. This increases the steps of operation as compared with the conventional method of providing only the IC card 212.

In addition, the card company ID needs to be registered with the electronic seal 216. When issuing the IC card 212, the card company inputs the ID number which identifies the company to the electronic seal 216. This presents various problems in the aspects of management and security. In the management aspect, related institutions need to determine, publicly announce and manage ID numbers which identify card companies and banks, which is an enormous amount of work. In the security aspect, it is not desirable to write data, such as the card company ID number, on the electronic seal 216 since the electronic seal 216 is used for authentication.

As described above, it is indispensable for authentication to use the three elements of the IC card 212, the electronic seal 216 and the host computer 213 connected to the remote server 211. This requires a great amount of change to the conventional authentication system which is used for the conventional IC card without an electronic seal. This imposes a huge amount of expense on the uses of the conventional system.

In order to use the electronic seal 216 to protect data stored in a memory card against illegal access, authentication requires the three elements of a personal computer, a memory card and the electronic seal 216. This requires the conventional system not using an electronic seal needs to be additionally provided with the card reader/writer 214 for communicating with the electronic seal 216 and an authentication processing section.

### SUMMARY OF THE INVENTION

According to one aspect of the invention, an electronic seal includes an input/output section for receiving a random number encrypted based on a prescribed key; and an advance authentication processing section for decrypting the encrypted and received random number based on a secret key related to the prescribed key and then encrypting the decrypted random number based on the secret key. The input/output section outputs the encrypted random number encrypted based on the secret key.

In one embodiment of the invention, the advance authentication processing section includes a secret key memory section for storing the secret key; a decryption section for decrypting the encrypted and received random number based on the secret key; and an encryption section for encrypting the decrypted random number based on the secret key.

In one embodiment of the invention, the electronic seal further includes a communication request section for outputting a communication request ID. The communication request section includes a memory section for storing the communication request ID; and a reading section for reading the communication request ID from the memory section and outputting the communication request ID.

In one embodiment of the invention, the random number encrypted based on the prescribed key is output from a memory medium. The input/output section is a reader/writer section for supplying a power to the memory medium.

In one embodiment of the invention, the prescribed key is a public key. The secret key forms a key pair with the public key based on one of an RSA cryptosystem and an elliptic curve cryptosystem.

In one embodiment of the invention, the electronic seal further includes a display section for displaying at least a mode menu and a mode execution result; a selection key for selecting a prescribed mode from a plurality of modes; a determination key for determining on the selected mode; a numeral setting key for setting a numerical value; and a start key for starting execution of the determined mode.

In one embodiment of the invention, an external shape of the electronic seal is one of a card-shape, a cylindrical shape, and a prism shape.

In one embodiment of the invention, the electronic seal further includes an initial setting mode section for receiving key information including the prescribed key and the secret key from an external device only once and retaining the key information; and a registered seal mode section for outputting the prescribed key.

In one embodiment of the invention, the electronic seal further includes a cancel mode section for canceling a result of advance authentication based on an operation of the advance authentication processing section.

In one embodiment of the invention, the electronic seal further includes a period setting mode section for outputting information representing an expiration time of a valid time period of use to an external device.

In one embodiment of the invention, the electronic seal further includes a times setting mode section for outputting information representing a valid number of times of use to an external device.

In one embodiment of the invention, the electronic seal further includes a sum setting mode section for outputting information representing an upper limit of a sum which can be spent in one transaction to an external device.

In one embodiment of the invention, the electronic seal further includes a clock mode section for displaying the current time on the display section.

According to another aspect of the invention, a memory medium includes an advance authentication processing section for generating a random number, encrypting the generated random number based on a prescribed key, decrypting a random number, encrypted based on a secret key related to the prescribed key, based on the prescribed key, and comparing the generated random number and the decrypted random number; and an input/output section for outputting the random number encrypted based on the prescribed key and receiving the random number encrypted based on the secret key.

In one embodiment of the invention, the advance authentication processing section includes a random number generation section for generating the random number; a prescribed key memory section for storing the prescribed key; an encryption section for encrypting the generated random number based on the prescribed key; a decryption section for decrypting the random number, encrypted based on the secret key, based on the prescribed key; a random number comparison section for comparing the generated random number and the decrypted random number; and a comparison result memory section for storing a result of comparison.

In one embodiment of the invention, the memory medium further includes a start signal generation section for generating a start signal based on a communication request ID. The start signal generation section includes a communication request ID memory section for storing the communication request ID; and a communication request ID comparison section for comparing a communication request ID which is input from an external device and the communication request ID stored in the communication request ID memory section. The communication request ID comparison section outputs the start signal when the input communication request ID; and the communication request ID stored in the communication request ID memory section match each other.

In one embodiment of the invention the input/output section receives the communication request ID from the external device.

In one embodiment of the invention, the prescribed key is a public key. The secret key forms a key pair with the public key based on one of an RSA cryptosystem and an elliptic curve cryptosystem.

In one embodiment of the invention, the memory medium further includes an access permission processing section for permitting an access when the result of comparison indicates that the generated random number and the decrypted random number match each other, and for prohibiting an access when the result of comparison indicates that the generated random number and the decrypted random number do not match each other.

In one embodiment of the invention, when the result of comparison indicates that the generated random number and the decrypted random number match each other, the access permission processing section permits an access and resets the result of comparison stored in the comparison result memory section.

In one embodiment of the invention, the memory medium further includes an initial setting mode section for setting a prescribed key which is input from an external device.

In one embodiment of the invention, the memory medium further includes a prescribed memory section, wherein the initial setting mode section outputs the input prescribed key to the prescribed key memory section.

In one embodiment of the invention, the memory medium further includes a cancel mode section for canceling a result of advance authentication based on an operation of the advance authentication processing section.

In one embodiment of the invention, the memory medium further includes a period setting mode section for prohibiting an access after an expiration time of a valid time period of use has passed.

In one embodiment of the invention, the memory medium further includes a times setting mode section for prohibiting an access when a number of times that the memory medium has been used exceeds a valid number of times of use.

In one embodiment of the invention., the memory medium further includes a sum setting mode section for prohibiting an access when a sum to be used exceeds an upper limit of a sum which can be spent in one transaction.

According to still another aspect of the invention, an advance authentication system includes a memory medium and an electronic seal. The memory medium includes a first advance authentication processing section for generating a random number and encrypting the generated random number based on a prescribed key, and a first input/output section for outputting the random number encrypted based on the prescribed key. The electronic seal includes a second input/output section for receiving the random number encrypted based on the prescribed key, and a second advance authentication processing section for decrypting the encrypted and received random number based on a secret key related to the prescribed key and then encrypting the decrypted random number based on the secret key. The second input/output section outputs the random number encrypted based on the secret key. The first input/output section receives the random number encrypted based on the secret key. The first advance authentication processing section decrypts the random number, encrypted based on the secret key, based on the prescribed key, and compares the generated random number and the random number decrypted based on the prescribed key. The memory medium and the electronic seal perform mutual data communication to perform advance authentication processing.

In one embodiment of the invention, the memory medium is one of an IC card and a memory card.

According to still another aspect of the invention, a mobile device includes an electronic seal. The electronic seal includes an input/output section for receiving a random number encrypted based on a prescribed key; and an advance authentication processing section for decrypting the encrypted and received random number based on a secret key related to the prescribed key and then encrypting the decrypted random number based on the secret key. The input/output section outputs the encrypted random number encrypted based on the secret key.

In one embodiment of the invention, the mobile device is a cellular phone detachably accommodating the electronic seal.

According to still another aspect of the invention, a vehicle start control apparatus includes a memory medium. The memory medium includes an advance authentication processing section for generating a random number, encrypting the generated random number based on a prescribed key, decrypting a random number, encrypted based on a secret key related to the prescribed key, based on the prescribed key, and comparing the generated random number and the decrypted random number; and an input/output section for outputting the random number encrypted based on the prescribed key and receiving the random number encrypted based on the secret key.

The function of the present invention will be described.

First, the current situation will be described. When using a card such as a conventional bank cash card, IC card or memory card, the user inserts the card into an apparatus and inputs, for example, a four-digit password which is predetermined for authentication.

Such an authentication system using a four-digit password has a low security level, since the password is easily analyzed by a computer. Thus, current authentication systems using a password already have problems in terms of security and some steps need to be taken.

When using an IC card as a credit card, even the password is not usually checked. Although authentication is possible by having the user provide his/her signature, it is very difficult for humans to visually confirm the authenticity of the signature. Currently, anybody who obtains the IC card, even if not the authentic user, can use the IC card with no problem.

Memory cards such as semiconductor memory mediums (for example, CF (Compact Flash), Smart Media (registered trademark), SD (Secure Digital) memory card, Memory Stick (registered trademark)) are being increased in capacity and decreased in size. The contents stored by these memory mediums are deeply related to private information of the user (for example, photo of the user's face, data on financial status, stocks and health of the user). These small-size cards are easily lost, and once lost, the damage is great because their memory capacity is large. Currently, anybody can read the contents of these cards. The security level of these cards is quite low.

One quick solution to solve this problem regarding cash cards is to increase the number of digits of the password. As the number of digits of the password is larger, it is more difficult to break the security. In this sense, this method is desirable. However, it imposes trouble on the user who needs to memorize a password of many digits. Passwords need to be frequently changed for improving security. This is inconvenient for the user. In addition to the cash cards, some security means is desired for credit cards and memory cards.

The present inventors proposed an authentication system in order to provide security to the cards described in Japanese Application No. 2002-225590. For authentication, this system requires three elements of (i) an electronic seal, (ii) card (e.g., an IC card, a memory card, or a cash card), and (iii) a host computer.

According to this system, the electronic seal is used for authentication, like a second card used for an IC card. For both the IC card and the electronic seal, the user is authenticated using encrypted key information. Since three elements of the electronic seal, the card, and the host computer are needed for authenticating the user, this system provides a high level of security.

However, this system has the following problems. First, this system requires a significant change in the structure of the systems designed for the conventional cards, which necessitates a huge investment in the equipment. Second, the user is required to carry both the card and the electronic seal, which is inconvenient.

The present invention provides a system which can be used in the system designed for the conventional cards and still guarantees a high level of security. According to the system of the present invention, a card (for example, an IC card, a memory card, or a cash card) and an electronic seal can communicate with each other using a key pair of a public key and a secret key. After advance authentication is performed between the card and the electronic seal, the card is permitted to be used a prescribed number of times (for example, once).

Advance authentication will be described in more detail. The electronic seal sends a communication request ID to the card, and the card checks the communication request ID. When the result of check is “OK”, the card sends a random number encrypted with a public key. The electronic seal decrypts the received data (encrypted random number) with a secret key to obtain the decrypted random number. The electronic seal then encrypts the decrypted random number with the secret key and sends the encrypted random number to the card. The card decrypts the received data (encrypted random number) with the public key to obtain the decrypted random number. The card determines whether the decrypted random number and the random number generated by the card match each other or not.

The public key data (in the card) and the secret key data (in the electronic seal) theoretically form a key pair together. It is one feature of the present invention to communicate an encrypted random number.

For example, the electronic seal is customized by registering key information, which is specific to each electronic seal, with the electronic seal. The registration can be performed only once. The key information of an unregistered electronic seal represents “all 1”. Registration is possible only when the key information is “all 1”. The customized electronic seal is submitted to a financial institution as the registered seal, and the financial institution registers the public key information stored in the electronic seal with a card and issues the card. This registration can be performed only once. In the case where a card reader/writer and a cell are built in the electronic seal, the electronic seal and the card can communication with each other. Using the electronic seal, the user can perform authentication with the card himself/herself. In this manner, a card which has been successfully subjected to advance authentication can be used in a traditional financial card system. No card without successful advance authentication is usable.

For example, using the customized electronic seal, the user can register the public key information with a memory card. This registration can be set to be permitted only once. The user performs advance authentication with a memory card using the electronic seal. A memory card successfully subjected to advance authentication can be accessed by a multi-purpose personal computer or the like. No access is permitted to a memory card without successful advance authentication. The memory card is usable in the conventional manner in the conventional system.

The card successfully subjected to advance authentication in this manner can communicate with the remote server via the host computer a prescribed number of times (for example, once). When the communication between the card and the remote server is permitted only once, the card can be used once without being subjected to authentication with the electronic seal at the store or the like. Before each use, the card is subjected to advance authentication (using the electronic seal); then it is not necessary to carry the electronic seal.

According to the present invention, it is not necessary to record the card company ID on the electronic seal. By registering the electronic seal with the card, the card can easily be issued. The conventional system which is used for methods without an electronic seal can be used without being changed and without being provided with additional elements. Since advance authentication of the user is performed by the electronic seal and the card, it is not necessary to provide the electronic seal to the other party of the transaction. Therefore, protection of cards against illegal access can be provided with high security.

The term “electronic seal” represents a device for performing authentication with the other party (here, cards) by data encryption and decryption using key information. The device, which is used like a second card, needs to be easily portable. The “other party” is not limited to cards. For example, authentication may be performed with a vending machine using the electronic seal to make a purchase (electronic money). The electronic seal may be usable in pay TV, game machines and phone devices. The electronic seal according to the present invention may be incorporated into items used in daily life, for example, cellular phones (including phones provided with an externally attached electronic seal), car keys (for prevention of car theft), wrist watches, and PDAs (personal digital assistants). The electronic seal can be significantly more easily used since authentication can be performed using the electronic seal function of these items. The market of the electronic seal is expected to be greatly expanded.

Thus, the invention described herein makes possible the advantages of providing an electronic seal usable to provide highly secure protection of cards against illegal access without troublesome operations or a huge amount of expense; memory devices such as, for example, an IC card and a memory card usable with the electronic seal; an advance authentication system using the same; and a mobile device, a cellular phone device, and a vehicle start control apparatus accommodating the same. The electronic seal according to the present invention does not require a card company ID number to be recorded thereon. By registering the electronic seal with a card, the card can be easily issued. The electronic seal does not require changes or provision of additional elements to the conventional system which is used without an electronic seal. Since advance authentication is performed using the electronic seal and the card, it is not necessary to provide the electronic seal to the other party of the transaction.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram illustrating an advance authentication system according to a first example of the present invention;

FIG. 2 is a block diagram illustrating a card reader/writer according to one example of the present invention;

FIG. 3 is a block diagram illustrating a security processing section according to one example of the present invention;

FIG. 4 is a block diagram illustrating a transmission and receipt/rectification/logic circuit according to one example of the present invention;

FIG. 5 is a block diagram illustrating a security processing section according to one example of the present invention;

FIG. 6 is a block diagram illustrating an access permission processing section according to one example of the present invention;

FIG. 7 is a block diagram illustrating a multi-mode advance authentication system according to a second example of the present invention;

FIG. 8 is a block diagram illustrating a multi-mode electronic seal according to one example of the present invention;

FIG. 9A is a perspective view of an external appearance of the multi-mode electronic seal shown in FIG. 8;

FIGS. 9B and 9C show alternative exemplary external shapes of the multi-mode electronic seal shown in FIG. 8;

FIG. 10 is a block diagram illustrating a multi-mode card according to one example of the present invention;

FIG. 11 is a block diagram illustrating an access permission processing section according to one example of the present invention;

FIG. 12A shows various fields to which an electronic seal according to the present invention is applicable;

FIG. 12B is a block diagram illustrating a mobile device according to the present invention;

FIG. 12C is a block diagram illustrating a vehicle start control apparatus according to the present invention;

FIG. 13 is a block diagram illustrating an exemplary authentication system;

FIG. 14 is a block diagram illustrating another exemplary authentication system; and

FIG. 15 is a flowchart illustrating an example of processing of an authentication system.

### DESCRIPTION OF THE PREFERRED EMBODIMENTS

Hereinafter, the present invention will be described by way of illustrative examples with reference to the accompanying drawings.

### EXAMPLE 1

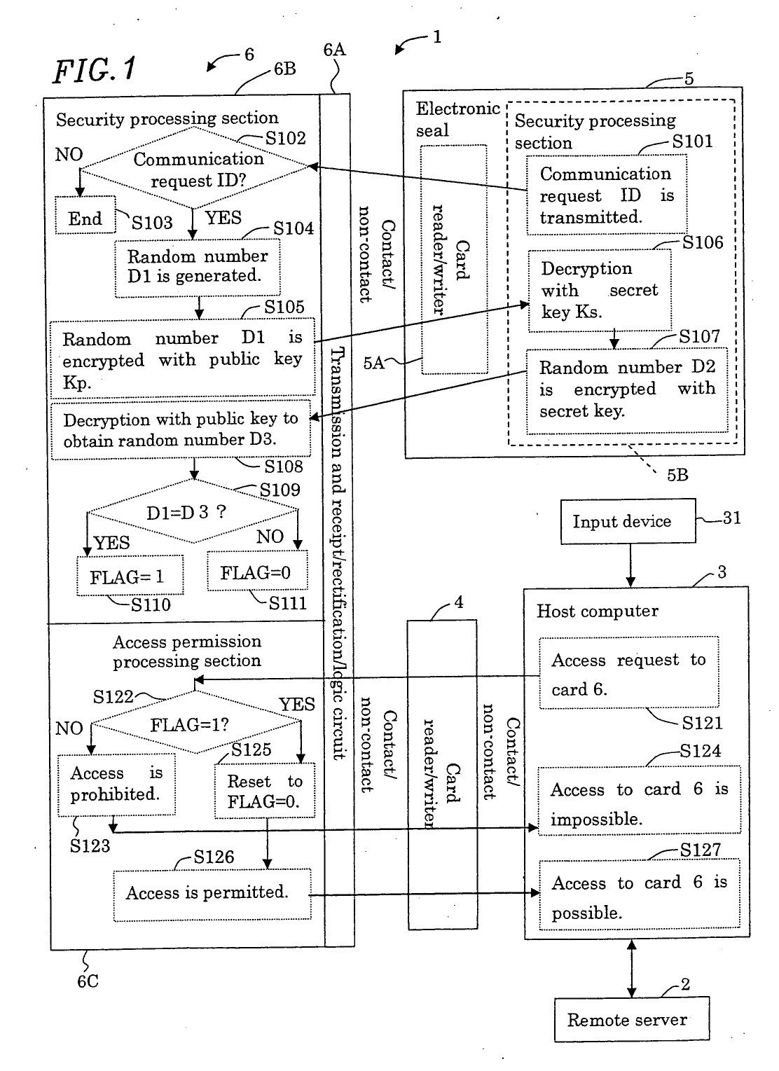

FIG. 1 is a block diagram of an advance authentication system 1 according to a first example of the present invention. FIG. 1 also shows a flowchart illustrating an operation of the elements of the advance authentication system 1.

The advance authentication system 1 includes a remote server 2, a host computer (or a personal computer) 3, a card reader/writer 4, an electronic seal 5 having an authentication function using a secret key, a card 6 having an authentication function using a public key which forms a key pair with the secret key, and an input device 31. The card reader/writer 4 acts as an input/output section, which is a communication interface between the electronic seal 5 and the card 6. The card 6 is a removable memory medium (detachable and portable memory medium) and is, for example, an IC card or a memory card.

The remote server 2 has various card-related information stored as a backup.

When instructed by the input device 31, the host computer 3 issues a card access request to the card 6.

Only when the user is confirmed to be an authentic user as a result of the security check, the host computer 3 is made communicable with the remote server 2, individual information in the card 6 and the like. After the user selects a service (selection execution processing), the host computer 3 displays or prints out the desired card-related information (service content output processing). Since real-time communication is necessary in order to access the remote server 2, the authentication is performed between the host computer 3, the electronic seal 5 and the card 6. As described in detail below, authentication is performed between the electronic seal 5 and the card 6 using the public key cryptosystem. When the user of the card 6 is confirmed to be authentic by the check between the host computer 3 and the card 6, the user is permitted to use the card 6, and the services are then displayed on a display of the host computer 3. When a type of service is selected by the user via the input device 31, the service is executed by the host computer 3.

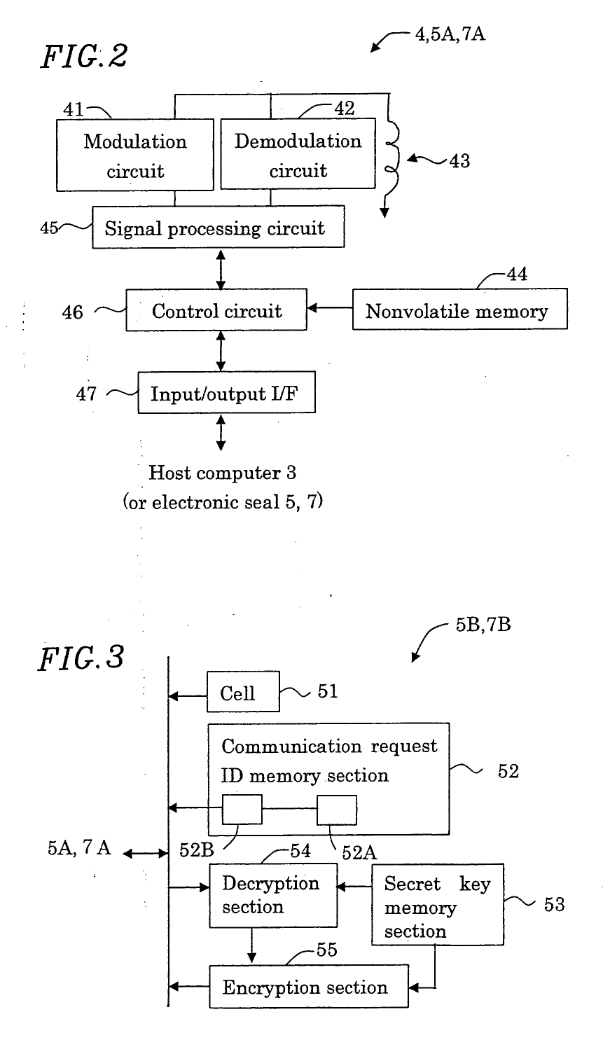

The card reader/writer 4 supplies power to the card 6 which can be of a non-contact type or a contact type. Data communication is performed for mutual security checking between, for example, the host computer 3 and the card 6 through the card reader/writer 4. An example of the card reader/writer 4 will be described with reference to FIG. 2.

FIG. 2 is a block diagram of the card reader/writer 4 shown in FIG. 1. The card reader/writer 4 acts as a communication interface between the host computer 3 and the card 6. The card reader/writer 4 is used between the host computer 3 and the card 6 for non-contact communication (wireless data transmission and receipt). Card reader/writers 5A and 7A described below which are built in an electronic seal have substantially the same structure as that of the card reader/writer 4 and each act as a communication interface between the electronic seal and a card.

Referring to FIG. 2, the card reader/writer 4 includes a modulation circuit 41, a demodulation circuit 42, an antenna circuit 43, a nonvolatile memory 44, a signal processing circuit 45, a control circuit 46, and an input/output I/F (interface) circuit 47.

The modulation circuit 41 modulates a signal from the signal processing circuit 45 so as to have a prescribed carrier wave and supplies the obtained carrier wave to the antenna circuit 43. For example, a carrier wave having a frequency of 13.56 MHz is sent by the antenna circuit 43 by the ASK (Amplitude Shift Keying) system.

The demodulation circuit 42 demodulates a prescribed carrier wave from the antenna circuit 43 and supplies the obtained carrier wave to the signal processing circuit 45.

The signal processing circuit 45 detects data input/output to and from the IC card 6 and the host computer 3 (or the electronic seal 5) based on the control by the control circuit 46, and processes the signal received during data transmission.

The control circuit 46 includes a CPU (central processing unit), a memory and the like therein. The control circuit 46 reads and starts a control program pre-recorded in the nonvolatile memory 44 so as to control each of the circuits included in the card reader/writer 4. The control circuit 46 also performs data communication with an upstream device such as the host computer 3 or the like via the input/output I/F circuit 47. The card reader/writer 5A and 7A respectively built in electronic seals 5 and 7 (described below) each perform data communication with security processing sections of the electronic seals 5 and 7, respectively.

The electronic seal 5 (FIG. 1) includes a card reader/writer 5A and a security processing section 5B. The security processing section 5B performs data communication with the card reader/writer 5A to act as a section for performing advance authentication processing (advance authentication processing section). The card reader/writer 5A has substantially the same structure as that of the card reader/writer 4 and will not be described in detail.

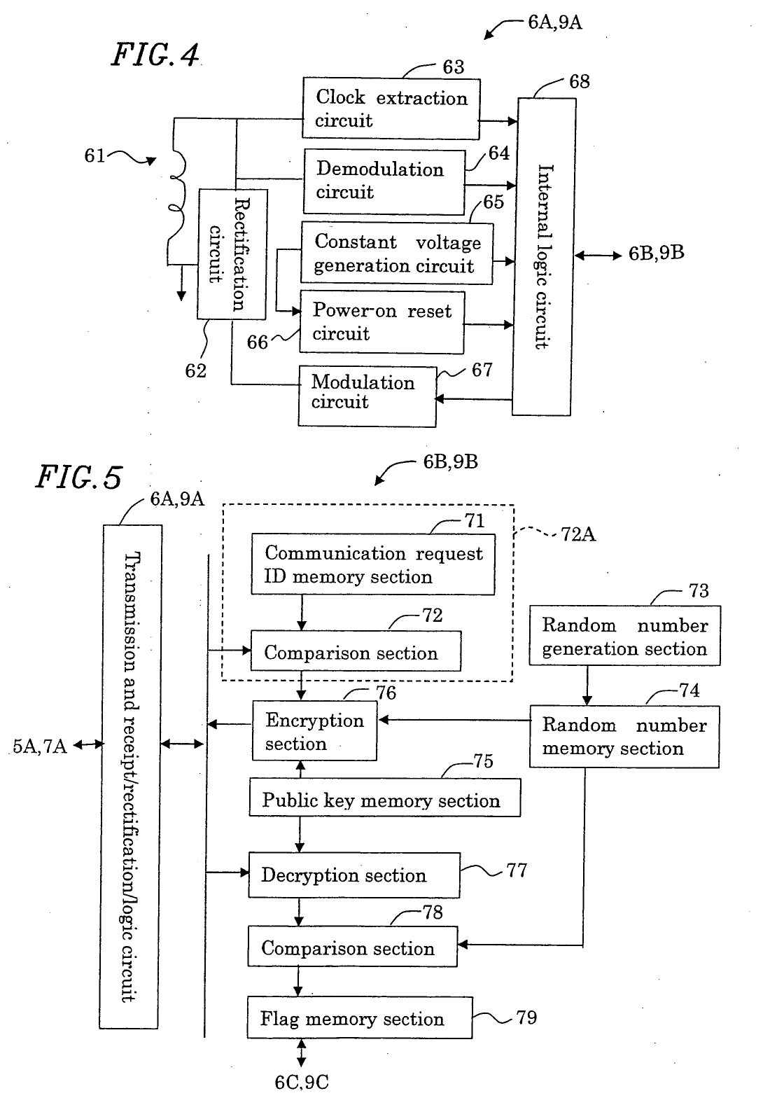

An example of the security processing section 5B will be described with reference to FIG. 3.

FIG. 3 is a block diagram of the security processing section 5B included in the electronic seal 5 (FIG. 1).

As shown in FIG. 3, the security processing section 5B includes a cell section 51 acting as a power supply section for generating a supply voltage, a communication request ID (Identification) memory section 52, a secret key memory section 53, a decryption section 54, and an encryption section 55.

The cell section 51 provides a power supply to the card 6 through the card reader/writer 5A in a wireless manner as well as being used as the power supply of the electronic seal 5.

The communication request ID memory section 52 acts as a communication request section. The communication request ID memory section 52 includes a memory section 52A for storing a communication request ID, and a data reading section 52B for reading the communication request ID as a communication request signal from the memory section 52A based on an operation instruction from the user. The communication request ID memory section 52 sends the read communication request ID to the card 6 to request the card 6 for communication.

The secret key memory section 53 stores secret key information of a secret key which forms a prescribed key pair with a public key described below. The secret key memory section 53 outputs the secret key information to the decryption section 54 and the encryption section 55 at prescribed timings.

The decryption section 54 decrypts an encrypted random number sent from the card 6 in response to the communication request (described below in detail) using the secret key indicated by the secret key information.

The encryption section 55 encrypts the decrypted random number using the secret key indicated by the secret key information and sends the encrypted random number to the card 6 through the card reader/writer 5A.

An example of the card 6 (FIG. 1) will be described.

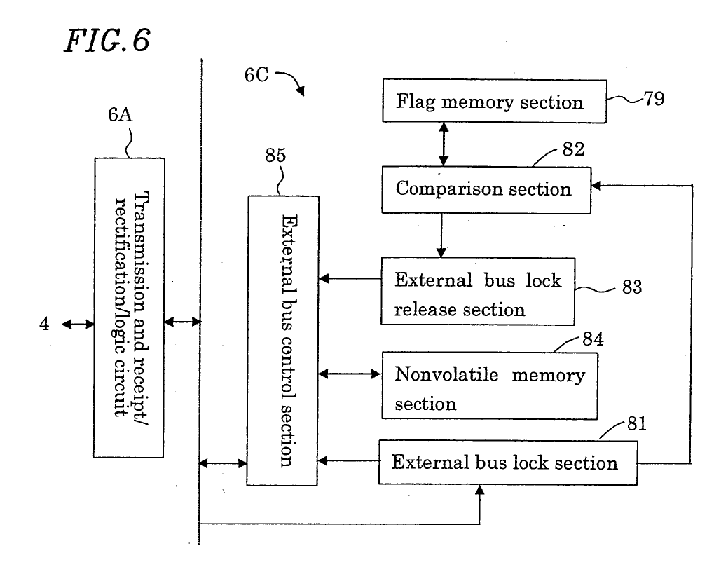

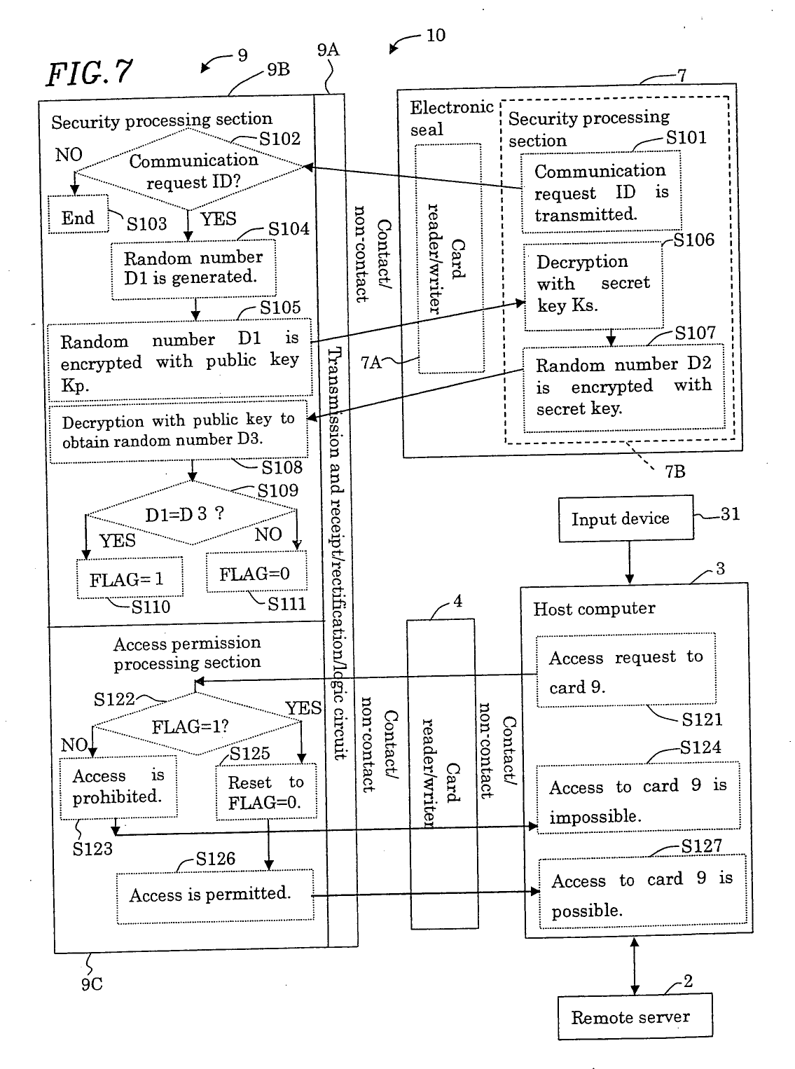

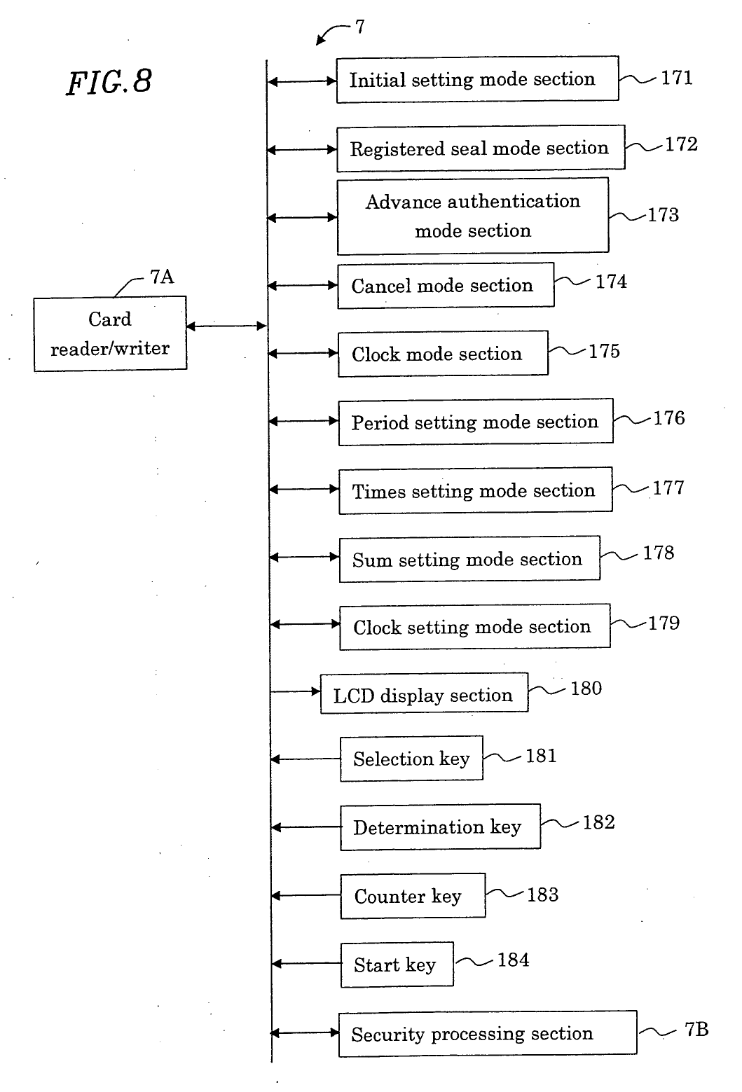

The card 6 includes a transmission and receipt/rectification/logic circuit 6A (FIG. 4), the security processing section 6B (FIG. 5), and an access permission processing section 6C (FIG. 6). The transmission and receipt/rectification/logic circuit 6A acts as an input/output section which is communicable with the card reader/writer 4 (or 5A). The security processing section 6B acts as an advance authentication processing section.

The card 6 is, for example, an IC card or a memory card. By registering the electronic seal 5 with the card 6 (i.e., by registering a key pair), the card 6 can be issued without incorporating the card company ID number into the electronic seal 5. An IC card can be used in the conventional manner without requiring the user to pay attention to the access permission processing inside the card 6, as long as the advance authentication processing has been performed. When the advance authentication processing has not been performed, the host computer 3 rejects use of the IC card. A memory card can be accessed in the conventional manner without requiring the user to pay attention to the access permission processing inside the card 6, as long as the advance authentication processing has been performed. When the advance authentication processing has not been performed, the host computer 3 rejects access to the memory card.

FIG. 4 is a block diagram of the transmission and receipt/rectification/logic circuit 6A included in the card 6 (FIG. 1).

Referring to FIG. 4, the transmission and receipt/rectification/logic circuit 6A includes an antenna 61, a rectification circuit 62, a clock extraction circuit 63, a demodulation circuit 64, a constant voltage generation circuit 65, a power-on reset circuit 66, a modulation circuit 67, and an internal logic circuit 68. The transmission and receipt/rectification/logic circuit 6A performs non-contact communication between the electronic seal 5/the host computer 3 and the card 6.

The antenna 61, the rectification circuit 62, the clock extraction circuit 63, and the demodulation circuit 64 are included in an input section (in this example, the input section is a receiving section but alternatively may be a contact section with the card reader/writer 4, 5A). The antenna 61, the rectification circuit 62, the modulation circuit 67, and the internal logic circuit 68 are included in an output section (in this example, the output section is a sending section but alternatively may be a contact section with the card reader/writer 4, 5A). The input section and the output section (receiving section and the sending section) are included in the input/output section (transmission and receipt section).

The antenna 61 is a transmission and receipt section, and receives signals from the card reader/writer 4 or 5A and also sends signals from the card 6 to the card reader/writer 4 or 5A.

The rectification circuit 62 rectifies a signal received via the antenna 61 and outputs the rectified signal to the clock extraction circuit 63 and the demodulation circuit 64. The rectification circuit 62 also rectifies a signal from the modulation circuit 67 and outputs the rectified signal to the antenna 61.

The clock extraction circuit 63 extracts a clock signal required for an operation of the internal logic circuit 68 and the like from a carrier wave from the card reader/writer 4 received via the antenna 61, and outputs the clock signal to the internal logic circuit 68.

The demodulation circuit 64 demodulates the signal from the card reader/writer 4 received via the antenna 61 and outputs the demodulated signal to the internal logic circuit 68.

The constant voltage generation circuit 65 outputs a constant voltage to the power-on reset circuit 66 and the internal logic circuit 68.

The power-on reset circuit 66 controls power shutoff/reset of the card 6, and outputs a control signal for power shutoff/reset to the internal logic circuit 68.

The modulation circuit 67 modulates a prescribed carrier wave so as to have an arbitrary wavelength based on the control by the internal logic circuit 68, and sends the obtained carrier wave to the card reader/writer 4 via the antenna 61.

The internal logic circuit 68 includes a CPU (central processing unit), a memory including a ROM and RAM, and the like, and controls each of the elements of the card 6.

FIG. 4 shows one example of the transmission and receipt/rectification logic circuit 6A when the card reader/writer 4, 5A and the card 6 communicate with each other in a non-contact manner. The present invention is not limited to such a structure, and other structures may be applied when, for example, the card reader/writer 4, 5A and the card 6 communicate with each other in a contact manner.

FIG. 5 is a block diagram of the security processing section 6B included in the card 6 (FIG. 1). The security processing section 6B acts as an advance authentication section of the card 6.

The security processing section 6B includes a communication request ID memory section 71, a comparison section 72 (communication request ID comparison section), a random number generation section 73, a random number memory section 74, a public key memory section 75, an encryption section 76, a decryption section 77, a comparison section 78 (random number comparison section), and a flag memory section 79 acting as a comparison result memory section.

The communication request ID memory section 71 includes a memory section for storing a communication request ID, and a data reading section for reading the communication request ID in the memory section. The communication request ID is also stored in the communication request ID memory section 52 of the electronic seal 5. In one embodiment, an encrypted communication request ID is stored in the communication request ID memory sections 52 and 71, so that the electronic seal 5 is specified and processing is performed at higher speed. In the case where the communication request ID of the electronic seal 5 is, for example, “Let's Start”, the “Let's Start” encrypted with the secret key is registered in the communication request ID memory sections 52 and 71 as a communication request. The post-encryption communication request ID is different for each electronic seal 5. Therefore, the electronic seal 5 can be easily specified by the card 6, so that the communication start between the electronic seal 5 and the card 6 can be easily controlled. Since the encrypted communication request ID is used as encrypted, the time for decryption is eliminated, and thus the speed of calculation is increased and energy is saved.

The comparison section 72 compares the communication request ID received from the electronic seal 5 and the communication request ID received from the communication request ID memory section 71. When the two IDs match each other, the encryption section 76 performs the encryption. When the two IDs do not match each other, the security processing is terminated. Namely, the comparison section 72 outputs a start signal to the encryption section 76 only when the communication request ID received from the electronic seal 5 and the communication request ID received from the communication request ID memory section 71 match each other. The communication request ID memory section 71 and the comparison section 72 form a start signal generation section 72A.

The random number generation section 73 generates a random number. The random number is generated based on a known pseudo random number generation method (for example, a random number generation method using hash function SHA-1 proposed in FIPS PUB 186-2).

The random number memory section 74 stores a random number generated by the random number generation section 73.

The public key memory section 75 stores public key information.

The encryption section 76 encrypts the random number output from the random number memory section 74 with a public key output from the public key memory section 75, and sends the encrypted random number to the electronic seal 5 through the transmission and receipt/rectification/logic circuit 6A. As the encryption system, RSA described below is usable, for example.

The decryption section 77 decrypts data received from the electronic seal 5 with the public key output from the public key memory section 75.

The comparison section 78 compares the data decrypted by the decryption section 77 with the random number stored in the random number memory section 74. When the data and the random number match each other, the comparison section 78 determines that the result of the advance authentication is “valid” and sets the flag memory section 79 to “1”. When the data and the random number do not match each other, the comparison section 78 determines that the result of the advance authentication is “invalid” and sets the flag memory section 79 to “0”.

The flag memory section 79 stores the comparison result as “1” (which indicates that the result of the advance authentication is “valid”) or as “0” (which indicates that the result of the advance authentication is “invalid”)

FIG. 6 is a block diagram of the access permission processing section 6C included in the card 6 (FIG. 1).

The access permission processing section 6C includes an external bus lock section 81, a comparison section 82, an external lock release section 83, a nonvolatile memory section 84, and an external bus control section 85.

The external bus lock section 81 disables access with an external bus (i.e., data write or data read). In more detail, when the host computer 3 tries to access the nonvolatile memory section 84 via the transmission and receipt/rectification/logic circuit 6A, the external bus lock section 81 places the external bus into a locked state via the external bus control section 85 using a signal from a power-on reset circuit 66 of the transmission and receipt/rectification/logic circuit 6A as a trigger. Thus, the access to the nonvolatile memory section 84 is disabled.

After the external bus lock section 81 executes the lock processing, the comparison section 82 checks if the value of the flag memory section 79 is “1” or not. When the value of the flag memory section 79 is “1”, the comparison section 82 resets the flag memory section 79 to “0”, and outputs a comparison result signal indicating “1” to the external bus lock release section 83. When the value of the flag memory section 79 is not “1”, the comparison section 82 outputs a comparison result signal indicating “0” to the external bus lock release section 83, and the processing is terminated.

When receiving the comparison result signal indicating “1” from the comparison section 82, the external bus lock release section 83 outputs a lock release signal to the external bus control section 85 to release the locked state of the external bus against the card 6. Thus, the data access between the card 6 and the external bus is permitted. When receiving the comparison result signal indicating “0” from the comparison section 82, the external bus lock release section 83 does not output a lock release signal to the external bus control section 85 and thus the external bus remain locked against the card 6. In this case, data access between the card 6 and the host computer 3 remains prohibited.

The nonvolatile memory section 84 is a memory area of the card 6 which is to be protected.

The external bus control section 85 is a bus control section provided between the nonvolatile memory section 84 and an interface for connection to an external device.

The secret key Ks of the electronic seal 5 is logically related to the public key Kp of the card 6. The public key Kp and the secret key Ks form a prescribed key pair by the various encryption systems (for example, the RSA system, or the elliptic curve encryption system). When the RSA system is used, the key pair is obtained as follows.

Two different prime numbers having a substantially equal size, p and q, are prepared, and n is obtained by expression (1).

n=p×q, p≠q expression (1)

The least common multiple of (p−1) and (q−1), namely, n1 is obtained by expression (2).

n1=LCM(p−1, q−1) expression (2)

e which is prime to n1 is obtained by expression (3).

GCD(e, n1)=1 expression (3)

d is obtained by expression (4). It is found that e⁻¹ exists from expression (3).

d=e⁻¹mod n1 expression (4)

The range of the key pair is 1<e, d<n1.

The public key Kp is (e, n), and the secret key Ks is (d).

With the calculation ability of currently available computers, security is retained as long as the length of the key (the length of the binary bit of n) is 1536.

When the elliptic curve cryptosystem is used, the key pair is obtained as follows.

As a prime number p, a 160-bit long binary prime number is selected at random.

As an elliptic curve E, a and b are selected so as to fulfill the condition of expression (5). Thus, the elliptic curve is determined.

(4a³+27b²*0mod p) expression (5)

As a generator G, one generation source of the elliptic curve is selected.

G=(X₀, Y₀) expression (6)

A random number is selected by expression (7) as a random natural number a, and a multiple A of point (generator) G of the elliptic curve is obtained by expression (8).

a∈{1, 2, . . . , #E-1} expression (7)

A=aG=(Xₐ, Yₐ) expression (8)

Here, #E is the order of the elliptic curve.

The public key is (E, p, #E, G, A), and the secret key is (a).

Table 1 summarizes the relationship between the cryptosystem and key information.

TABLE 1

| Encryption | Identification | | |
|---|---|---|---|
| system | number | Public key Kp | Secret key Ks |
| RSA | 1 | e, n | d |
| Elliptic | 2 | E, p, #E, G, A | a |
| curve | | | |

The public key Kp is conveniently freely used by related institutions such as, for example, card companies. The secret key Ks is isolated in the electronic seal 5 and is not accessible, thus improving the security.

Hereinafter, an exemplary operation of the advance authentication system 1 of the first example will be described mainly with reference to FIG. 1.

In step S101, the communication request ID stored in the communication request ID memory section 52 (FIG. 3) is sent from the card reader/writer 5A built in the electronic seal 5 to the card 6 to request the card 6 for communication with the electronic seal 5.

Instep S102, the card 6 compares the communication request ID received from the electronic seal 5 with the communication request ID stored in the communication request ID memory section 71 (FIG. 5). When the two IDs do not match each other (NO in step S102), the processing is terminated in step S103. When the two IDs match each other (YES in step S102), the processing proceeds to step S104.

Instep S104, the random number generation section 73 generates random number D1 and stores random number D1 in the random number memory section 74.

In step S105, the encryption section 76 encrypts random number D1 based on the public key Kp. The transmission and receipt/rectification/logic circuit 6A sends the encrypted random number D1 to the card reader/writer 5A.

In step S106, the decryption section 54 (FIG. 3) of the electronic seal 5 decrypts the received encrypted random number D1 based on the secret key Ks. Thus, random number D2, which is the decrypted random number D1, is obtained.

In step S107, the encryption section 55 encrypts random number D2 based on the secret key Ks. The encryption section 55 sends the encrypted random number D2 to the transmission and receipt/rectification/logic circuit 6A of the card 6 via the card reader/writer 5A of the electronic seal 5.

In step S108, the decryption section 77 (FIG. 5) of the card 6 decrypts the received encrypted random number D2 based on the public key Kp. Thus, random number D3, which is the decrypted random number D2, is obtained.

In step S109, random number D1 generated in step S104 and random number D3 generated in step S108 are compared with each other. When the random numbers match each other (YES in step S109), the processing proceeds to step S110. The result of the advance authentication is determined to be “valid”, and the flag memory section 79 (FIG. 5) is set to “1”. Thus, the user of the card 6 is confirmed to be authentic.

When the random numbers do not match each other (NO in step S109), the processing proceeds to step S111. The result of the advance authentication is determined to be “invalid”, and the flag memory section 79 is set to “0”. Thus, the user of the card 6 is not confirmed to be authentic.

After the advance authentication processing (steps S101 through S111), in step S121, the host computer 3 sends a card access request to the transmission and receipt/rectification/logic circuit 6A through the card reader/writer 4 based on a user input from the input device 31.

At this stage, access to the nonvolatile memory section 84 of the card 6 is disabled by the external bus lock section 81 (FIG. 6). In step S122, the comparison section 72 checks if the value of the flag memory section 79 is “1” or not. When the value of the flag memory section 79 is not “1” (NO in step S122), the access is determined to be “prohibited” in step S123 and the locked state of the external bus is maintained. The determination result is sent from the transmission and receipt/rectification/logic circuit 6A to the host computer 3 via the card reader/writer 4. In step S124, the host computer 3 detects that the card 6 is inaccessible, and the processing is terminated.

When the value of the flag memory section 79 is “1” (YES in step S122), the value of the flag memory section 79 is updated to “0” in step S125. Then, in step S126, the access is determined to be “permitted” and the external bus is released from the locked state. The determination result is sent from the transmission and receipt/rectification/logic circuit 6A to the host computer 3 via the card reader/writer 4. In step S127, the host computer 3 detects that the card 6 is accessible, and the user of the card is admitted as being authentic as a result of the security processing.

After the user is successfully admitted as being authentic in this manner, the communication between the host computer 3 and the remote server 2 is made possible. After the user selects a service, the host computer 3, for example, displays or prints out desired card-related information in the remote server 2 as the service content output processing.

### EXAMPLE 2

In the first example, the advance authentication system 1 including the electronic seal 5 and the card 6 was described. In a second example of the present invention, a multi-mode advance authentication system including a multi-mode electronic seal and a multi-mode card for executing multi-mode advance authentication which provides more functions will be described.

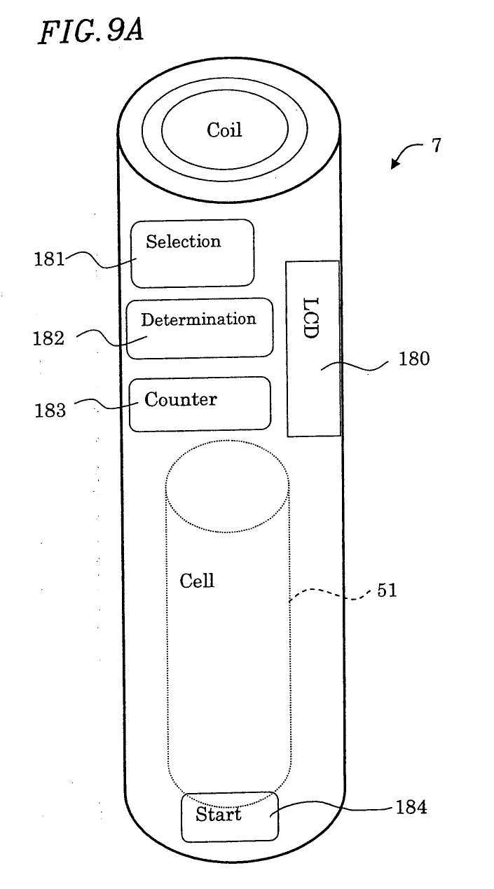

FIG. 7 is a block diagram of a multi-mode advance authentication system 10 according to a second example of the present invention. FIG. 7 also shows a flowchart illustrating operations of the elements of the multi-mode advance authentication system 10. Identical elements to those in FIG. 1 bear identical reference numerals and detailed descriptions thereof will be omitted.

The multi-mode advance authentication system 10 includes a remote server 2, a host computer (or a personal computer) 3, a card reader/writer 4, a multi-mode electronic seal 7 having an authentication function using a secret key, a multi-mode card 9 having an authentication function using a public key which forms a key pair with the secret key, and an input device 31. The card reader/writer 4 acts as an input/output section, which is a communication interface between the multi-mode electronic seal 7 and the multi-mode card 9. The multi-mode card 9 is a removable memory medium (detachable and portable memory medium) and is, for example, an IC card or a memory card.

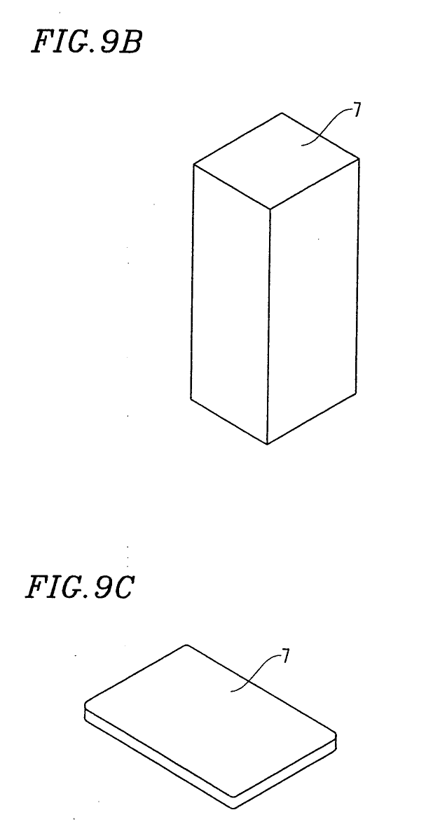

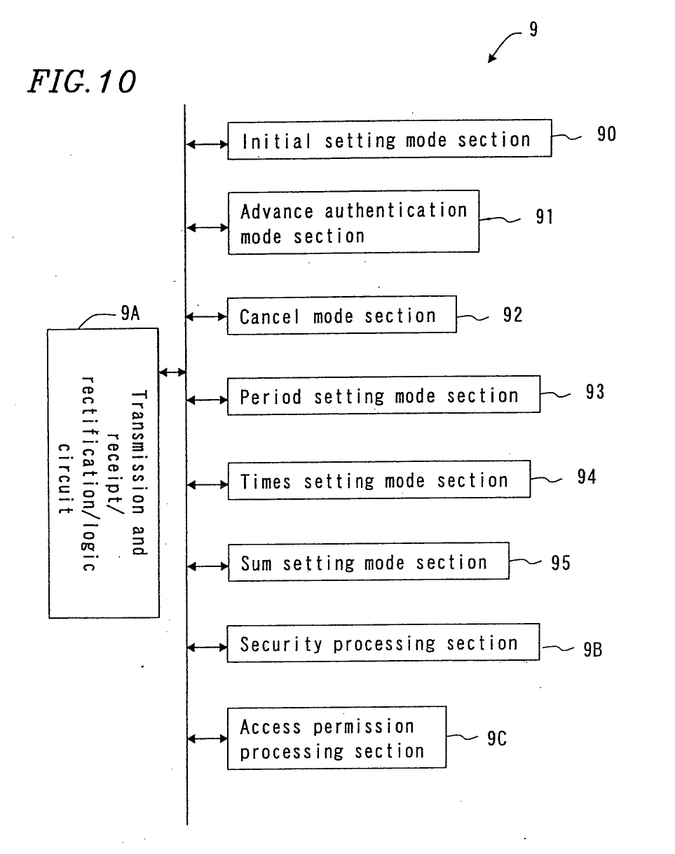

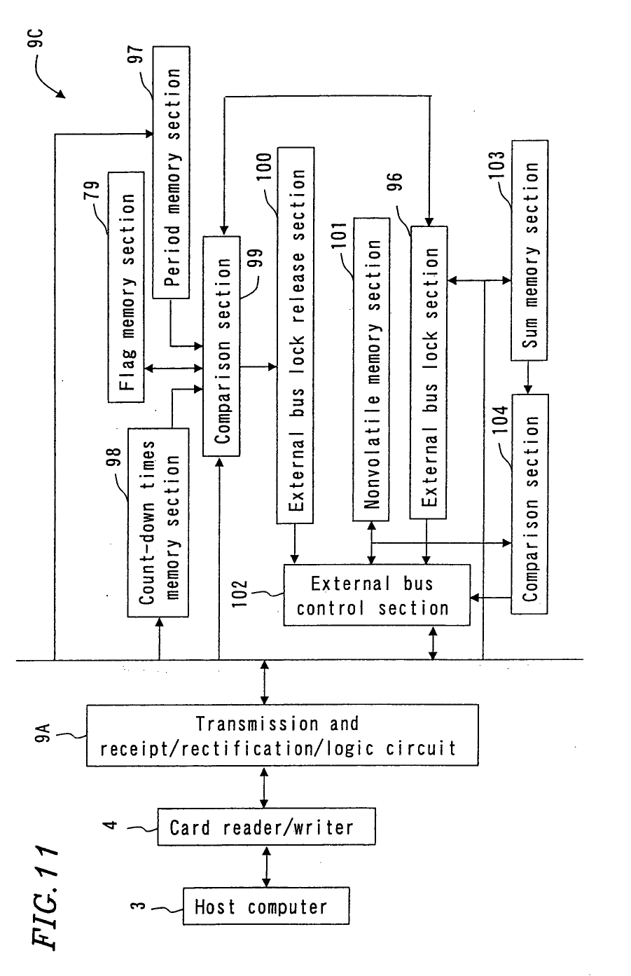

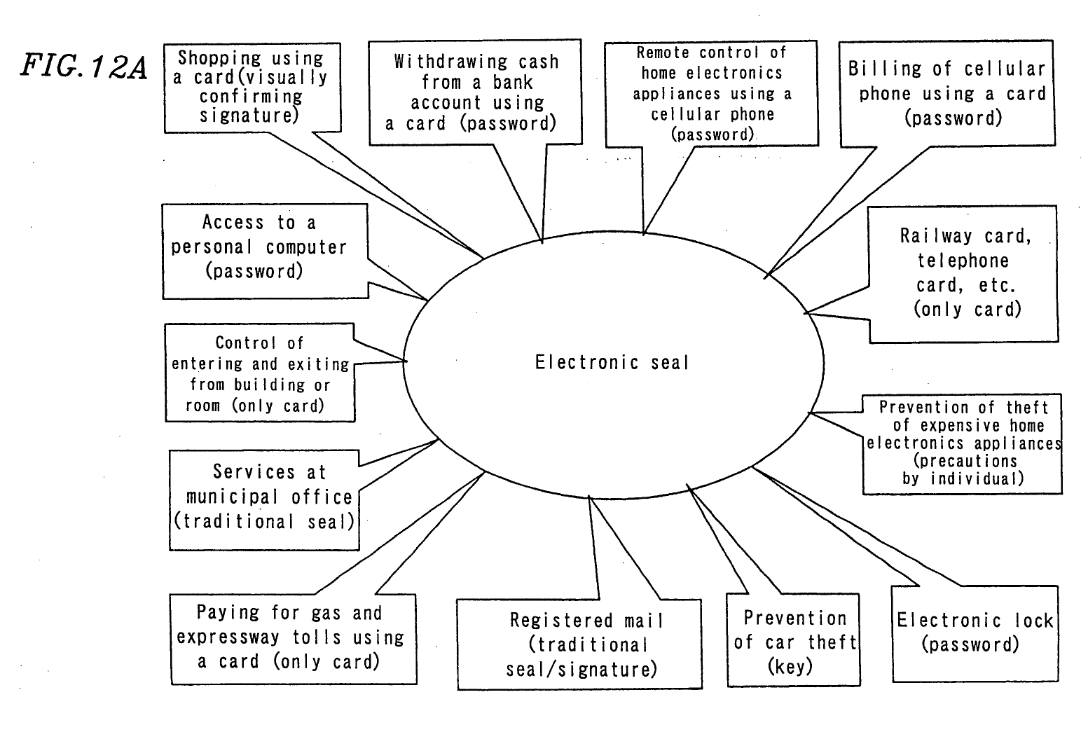

The multi-mode advance authentication system 10 is different from the advance authentication system 1 in having multi-mode functions of the multi-mode electronic seal 7 (FIGS. 8 and 9A) and the multi-mode card 9 (FIGS. 10 and 11).

The multi-mode electronic seal 7 includes a card reader/writer 7A and a security processing section 7B as shown in FIG. 7. The card reader/writer 7A and the security processing section 7B have substantially the same structure as that of the card reader/writer 5A and the security processing section 5B described above with reference to FIGS. 2 and 3. The security processing section 7B acts as an advance authentication processing section.

FIG. 8 is a block diagram of the multi-mode electronic seal 7 in the second example. FIG. 9A is a perspective view of an exemplary external appearance of the multi-mode electronic seal 7 shown in FIG. 8. The external shape of the electronic seal 7 may be cylindrical as shown in FIG. 9A, prism-shaped as shown in FIG. 9B, or card-shaped as shown in FIG. 9C. The electronic seal 5 described in the first example may also be cylindrical, prism-shaped or card-shaped. Alternatively, the electronic seals 5 and 7 also can have any other shape.

With reference to FIGS. 8 and 9A, the multi-mode electronic seal 7 further includes an initial setting mode section 171, a registered seal mode section 172, an advance authentication mode section 173, a cancel mode section 174, a clock mode section 175, a period setting mode section 176, a times setting mode section 177, a sum setting mode section 178, a clock setting mode section 179, an LCD display section 180, a selection key 181, a determination section 182, a counter key 183 and a start key 184. The LCD display section 180 displays at least a mode menu and a mode execution result.

The initial setting mode section 171 receives key information to be registered with the multi-mode electronic seal 7 (information on public key, secret key, etc.) from an external device and retains such information. The key information is initially set in a key information memory section (not shown) in the initial setting mode section 171 using a special device for initial setting which is available at key management centers or electric appliance shops. Before the initial setting is performed, all the information stored in the key information memory section is set to be “1”. Only in this state, key information can be initially set in the key information memory section. Namely, only when the information stored in the key information memory section shows a specific data sequence at the initial registration, key information can be set. The initial setting mode section 171 stores the received key information in the secret key memory section 53. As a result of the setting, “OK” or “NG” is displayed on the LCD display section 180. The “OK” indicates that the initial setting mode is completely executed. The “NG” indicates that initial setting is impossible. The letters displayed on the LCD display section 180 notifies the user of the setting result. The initial setting is controlled by a CPU in the control circuit 46 shown in FIG. 2 as follows.

A desired mode (the initial setting mode in this example) is selected among various modes displayed on the LCD display section 180 using the selection key 181, and selection of the initial setting mode is confirmed (i.e., the selection of the initial setting mode is determined) by hitting the determination key 182. Then, the start key 184 is continuously pushed until the selected initial setting mode is executed and “OK” or “NG” is displayed on the LCD display section 180. Then, the start key 184 is released. Thus, the initial setting mode is completed.

The registered seal mode section 172 outputs the public key stored in the multi-mode electronic seal 7 by the initial setting mode section 171 to the multi-mode card 9 (FIG. 7) for registration processing. A series of operations of the registered seal mode section 172 (i.e., mode selection by the selection key 181, the confirmation (or determination) of the selection by the determination key 182, execution by the start key 184, and display of the execution result on the LCD display section 180) are the same as those of the initial setting mode section 171.

When an advance authentication mode is determined to be executed by the user, the advance authentication mode section 173 instructs the communication request ID memory section 52 (FIG. 3) to send a communication request ID to the multi-mode card 9. The advance authentication mode section 173 sends the period, number of times and sum of the transaction which are set by the user in the multi-mode card 9 while executing an advance authentication processing between a security processing section 9B of the multi-mode card 9 (FIG. 7) and the security processing section 7B. In the case where the multi-mode card 9 is a memory card which cannot have the sum recorded therein, the sum of the transaction is not recorded in the multi-mode card 9. The advance authentication mode section 173 may be incorporated into the security processing section 7B. The series of operations regarding the advance authentication mode section 173 (i.e., mode selection by the selection key 181, the confirmation of the selection by the determination key 182, execution by the start key 184, and display of the execution result on the LCD display section 180) are the same as those of the initial setting mode section 171.

The cancel mode section 174 cancels the result of the advance authentication which is performed between the security processing section 9B and the security processing section 7B. In more detail, the cancel mode section 174 outputs an instruction to the multi-mode card 9 to cancel the result of the advance authentication processing from the authenticated multi-mode card 9 (for example, from the flag memory section 79). The series of operations regarding the cancel mode section 174 (i.e., mode selection, the confirmation of the selection, and execution, and display of the execution result) are the same as those of the initial setting mode section 171.

The clock mode section 175 displays time information such as, for example, year, month, day, and time on the LCD display section 180. Unless specific operations are performed, the multi-mode electronic seal 7 automatically selects the clock mode using the clock mode section 175 and displays year, month, day and time on the LCD display section 180.

The period setting mode section 176 sends information to the multi-mode card 9, which indicates the year/month/day (expiration date of the valid time period) or the year/month/day/time (expiration time of the valid time period) obtained by adding the set number of days to the day/time indicated by the clock mode section 175. In the period setting mode, the numerical value representing the valid time period (number of days, or expiration date or time of the valid time period) is input to the period setting mode section 176 with the counter key 183, and the period setting mode section 176 stores the numerical value in a built-in memory. The data registered in this manner can be rewritten repeatedly. The period setting mode is selected among various modes with the selection key 181, and the selection of the period setting mode is confirmed with the determination key 182. The numerical value (day/time) is set with the counter key 183 while monitoring the values displayed on the LCD display section 180. The set numerical value (day/time) is recorded on a memory (for example, the nonvolatile memory 44 (FIG. 2). Since execution of this mode is irrelevant to the devices other than multi-mode electronic seal 7, the modulation circuit 41 and the decryption circuit 42 may be omitted.

The times setting mode section 177 records, in a built-in memory, a valid number of times of use (i.e., the number of times that the multi-mode card 9 can be used) by performing the advance authentication once. The times setting mode section 177 sends information indicating the valid number of times of use to the multi-mode card 9. The data registered in this manner can be rewritten repeatedly. The series of operations regarding the times setting mode section 177 are the same as those of the period setting mode section 176.

The sum setting mode section 178 sets the upper limit of the sum which can be spent in each transaction of the multi-mode card 9. The sum setting mode section 178 sends information indicating the upper limit of the sum to the multi-mode card 9. The data registered in this manner can be rewritten repeatedly. The series of operations regarding the sum setting mode section 178 are the same as those of the period setting mode section 176.

The clock setting mode section 179 sets the year/month/day/time (current time). The series of operations regarding the clock setting mode section 179 are the same as those of the period setting mode section 176.

The LCD display section 180 displays, for example, a setting menu which is an initial setting screen displaying a plurality of modes, and an execution result screen showing the execution result of the selected mode. A driver (not shown) for driving the LCD display section 180 may be incorporated into the control circuit 46 (FIG. 2).

The selection key 181 is used for selecting a desired mode among the plurality of modes. The mode selection operation may be executed using the CPU in the control circuit 46.

The determination key 182 is used for confirming the selection of the specific mode. The mode determination operation may be executed using the CPU in the control circuit 46.

The counter key 183 is used for setting a numerical value as, for example, a valid time period, a valid number of times of use, an upper limit of the sum, and a current time.

The start key 184 is pressed for starting the execution of the selected mode. The execution start operation may be executed using the CPU in the control circuit 46. By pressing the start key 184, processing using the initial setting mode section 172, the registered seal mode section 172, the advance authentication mode section 173, the cancel mode section 174 is performed. When the start key 184 is released, the execution of the mode is terminated.

Table 2 shows modes executed by the multi-mode electronic seal 7.

TABLE 2

| | | | Related | Method of |
|---|---|---|---|---|
| Mode | Key | Processing | device | confirmation |
| Initial setting | Selection, | Registra- | Special | LCD (OK, NG) |
| | Determina- | tion of key | device | |
| | tion | information | | |
| Registered seal | Selection, | Output of | Card | LCD (OK, NG) |
| | Determina- | public key | | |
| | tion | | | |
| Advance | Selection, | Acknowl- | Card | LCD (OK, NG) |
| authentication | Determina- | edgement, | | |
| | tion | and output of | | |
| | | content of | | |
| | | acknowl- | | |
| | | edgement | | |
| Cancel | Selection, | Cancel of | Card | LCD (OK, NG) |
| | Determina- | acknowl- | | |
| | tion | edgement | | |
| Period setting | Selection, | Recording of | None | LCD (numerical |
| | Determina- | set | | value) |
| | tion, | numerical | | |
| | Counter | value | | |
| Times setting | Selection, | Recording of | None | LCD (numerical |
| | Determina- | set | | value) |
| | tion, | numerical | | |
| | Counter | value | | |
| Sum setting | Selection, | Recording of | None | LCD (numerical |
| | Determina- | set | | value) |
| | tion, | numerical | | |
| | Counter | value | | |
| Clock setting | Selection, | Adjustment | None | LCD (numerical |
| | Determina- | of the clock | | value) |
| | tion, | | | |
| | Counter | | | |

The multi-mode card 9 includes a transmission and receipt/rectification/logic circuit 9A (FIG. 7), the security processing section 9B (FIG. 10), and an access permission processing section 9C (FIG. 10). The transmission and receipt/rectification/logic circuit 9A and the security processing section 9B have the same structure as those of the transmission and receipt/rectification/logic circuit 6A and the security processing section 6B described above with reference to FIGS. 4 and 5. The security processing section 9B acts as an advance authentication processing section.

FIG. 10 is a block diagram of the multi-mode card 9 in the second example.

With reference to FIG. 10, the multi-mode card 9 further includes an initial setting mode section 90, an advance authentication mode section 91, a cancel mode section 92, a period setting mode section 93, a times setting mode section 94, and a sum setting mode section 95.

The initial setting mode section 90 executes the processing for registering the public key in the multi-mode electronic seal 7 in the multi-mode card 9. The processing can be performed by the user himself/herself. For example, when the multi-mode card 9 is issued, the user can register the multi-mode electronic seal 7 for identity confirmation. The initial setting can be performed only once for one multi-mode card 9. The initial setting mode section 90 outputs the public key received from the registered seal mode section 172 of the multi-mode electronic seal 7 to the public key memory section 75 (FIG. 5) and store the public key therein. The initial setting mode section 90 sends the result of setting of the multi-mode card 9 (“OK” or “NG”) to the multi-mode electronic seal 7, and the multi-mode electronic seal 7 displays the result on the LCD display section 180.

The advance authentication mode section 91 sends the result of the advance authentication processing performed between the security processing section 9B and the security processing section 7B (“OK” or “NG”) to the multi-mode electronic seal 7, and the multi-mode electronic seal 7 displays the result on the LCD display section 180. The advance authentication mode section 91 may be incorporated into the security processing section 9B.

The cancel mode section 92 cancels the result of the advance authentication performed between the security processing section 9B and the security processing section 7B to the authenticated multi-mode card 9 (for example, from the flag memory section 79). In more detail, upon receiving an instruction to cancel the result of the advance authentication from the cancel mode section 174, the cancel mode section 92 executes the advance authentication in cooperation with the advance authentication mode section 91. When the multi-mode electronic seal 7 is authentic (when the result of the advance authentication is “OK”), the cancel mode section 92 cancels the result of the advance authentication, and then sends the result of the cancel (“OK”) to the multi-mode electronic seal 7. When the result of the advance authentication is “NG”, the multi-mode electronic seal 7 is not authentic. Therefore, the cancel mode section 92 maintains the result of the advance authentication retained by the multi-mode card 9 and sends the result of the cancel (“NG”) to the multi-mode electronic seal 7. This mode can be correctly executed even to a multi-mode card 9 which is not successfully subjected to the advance authentication. This mode can be executed for invalidating the result of the advance authentication without fail.

The period setting mode section 93 receives the information output from the period setting mode 176 (FIG. 8) of the multi-mode electronic seal 7 and stores the information in a built-in memory. The information indicates the expiration date (or time) of the valid time period. When the current time passes the expiration date (or time) (i.e., after an expiration time of a valid time period of use has passed), the period setting mode section 93 outputs a prohibition instruction to prohibit access to an external bus control section 102 (FIG. 11). Upon receiving the prohibition instruction, the external bus control section 102 places the external bus into a locked state.

The times setting mode section 94 receives the information output from the times setting mode section 177 (FIG. 8) of the multi-mode electronic seal 7 and stores the information in a built-in memory. The information indicates the valid number of times of use (i.e., the number of times that the multi-mode card 9 can be used) by performing the advance authentication once. When the number of times that the multi-mode card 9 has been used exceeds the valid number of times of use, the times setting mode section 94 outputs a prohibition instruction to prohibit access to the external bus control section 102 (FIG. 11). Upon receiving the prohibition instruction, the external bus control section 102 places the external bus into a locked state.

The sum setting mode section 95 receives the information output from the sum setting mode section 178 (FIG. 8) of the multi-mode electronic seal 7 and stores the information in a built-in memory. The information indicates the upper limit of the sum which can be spent in each transaction of the multi-mode card 9. When the sum to be used exceeds the upper limit, the sum setting mode section 95 outputs, to the external bus control section 102, a prohibition instruction to prohibit access (FIG. 11). Upon receiving the prohibition instruction, the external bus control section 102 places the external bus into a locked state.

Table 3 shows modes executed by the multi-mode card 9.

TABLE 3

| | Identification | | Related | Method of |
|---|---|---|---|---|
| Mode | method | Processing | device | confirmation |
| Initial | Registered seal | Registra- | Electronic | Electronic |
| setting | mode of | tion of | seal | seal |
| | electronic seal | public key | | |
| Advance | Acknowl- | Acknowl- | Electronic | Electronic |
| authen- | edgement mode of | edgement, | seal | seal |
| tication | electronic seal | and | | |
| | | recording of | | |
| | | content of | | |
| | | acknowl- | | |
| | | edgement | | |
| Cancel | Cancel mode of | Cancel of | Electronic | Electronic |
| | electronic seal | acknowl- | seal | seal |
| | | edgement | | |

FIG. 11 is a block diagram of the access permission processing section 9C shown in FIG. 7.

The access permission processing section 9C includes an external bus lock section 96, a period memory section 97, a count-down times memory section 98, a comparison section 99, an external bus lock release section 100, a nonvolatile memory section 101, the external bus control section 102, a sum memory section 103, and a comparison section 104.

The external bus lock section 96 disables access to and from an external bus (i.e., data write or data read). In more detail, when the host computer 3 tries to access the nonvolatile memory section 101 via the transmission and receipt/rectification/logic circuit 9A, the external bus lock section 96 places the external bus into a locked state via the external bus control section 102 using a signal from a power-on reset circuit 66 of the transmission and receipt/rectification/logic circuit 9A as a trigger. Thus, the access to the nonvolatile memory section 101 is disabled.

The period memory section 97 stores a valid time period.

The count-down times memory section 98 subtracts the value “1” from the number of times stored in a built-in memory using a signal from the power-on reset circuit 66 of the transmission and receipt/rectification/logic circuit 9A as a trigger (FIG. 4). The count-down times memory section 98 again stores the result of calculation therein.

After the external bus lock section 96 places the external bus into a locked state, the comparison section 99 checks the data stored in the flag memory section 79, the period memory section 97, and the count-down times memory section 98. When the value stored in the flag memory section 79 is “1”, the comparison section 99 continues the comparison processing. The comparison section 99 compares the value stored in the period memory section 97 with the year/month/day/time obtained from the host computer 3. When the year/month/day/time obtained from the host computer 3 is within the valid time period, the comparison section 99 continues the processing.

The comparison section 99 checks the value stored in the count-downtimes memory section 98. When the value stored in the count-down times memory section 98 is positive, the comparison section 99 instructs the external bus lock release section 100 to release the external bus from the locked state. Upon receiving the instruction, the external bus lock release section 100 releases the external bus from the locked state. When the value stored in the flag memory section 79 is “0”, the processing is terminated.

When the current time passes the expiration date (or time) of the valid time period, or when the value stored in the count-down times memory section 98 is negative, the comparison section 99 sets the flag memory section 79 to “0”, the processing is terminated.

The nonvolatile memory section 101 is a memory area of the multi-mode card 9 which is to be protected.

The external bus control section 102 is a bus control section provided between the nonvolatile memory section 101 and an interface for connection to an external device.

The sum memory section 103 stores the upper limit of the sum which can be spent in each transaction of the multi-mode card 9. The sum memory section 103 is included in an IC card but not in a memory card.

The comparison section 104 monitors the value of the sum recorded in the nonvolatile memory section 101. When the value of the sum recorded in the nonvolatile memory section 101 exceeds the upper limit, the comparison section 104 places the external bus of the multi-mode card 9 into a locked state, thus to prohibit use of the multi-mode card 9. The comparison section 104 is included in an IC card but not in a memory card.

As described above, in the first and second examples of the present invention, a communication request ID is sent from the electronic seal 5 or 7 to the card 6 or 9. The card 6 or 9 checks the communication request ID. When the result of check is “OK”, the security processing section 6B of the card 6 or the security processing section 9B of the card 9 sends a random number encrypted with a public key to the electronic seal 5 or 7. The electronic seal 5 or 7 decrypts the received data (encrypted random number) with a secret key to obtain the decrypted random number. The electronic seal 5 or 7 then encrypts the decrypted random number with the secret key and sends the encrypted random number to the card 6 or 9. The card 6 or 9 decrypts the received data (encrypted random number) with the public key to obtain the decrypted random number. The card 6 or 9 determines whether or not the decrypted random number and the random number generated by the card 6 or 9 match each other.

The card 6 or 9 successfully subjected to advance authentication in this manner can communicate with the remote server 2 via the host computer 3 a prescribed number of times (for example, once). When the communication between the card 6 or 9 and the remote server 2 is permitted only once, the card 6 or 9 can be used once without requiring advance authentication. Before each use, the card 6 or 9 is subjected to advance authentication; then it is not necessary to carry the electronic seal 5 or 7.

According to the present invention, it is not necessary to record the card company ID on the electronic seal. By registering the electronic seal with the card, the card can easily be issued. The conventional system which is used for methods without an electronic seal can be used without being changed and without being provided with additional elements. Since advance authentication of the user is performed by the electronic seal and the card, it is not necessary to provide the electronic seal to the other party of the transaction. Therefore, protection of cards against illegal access can be provided with high security.

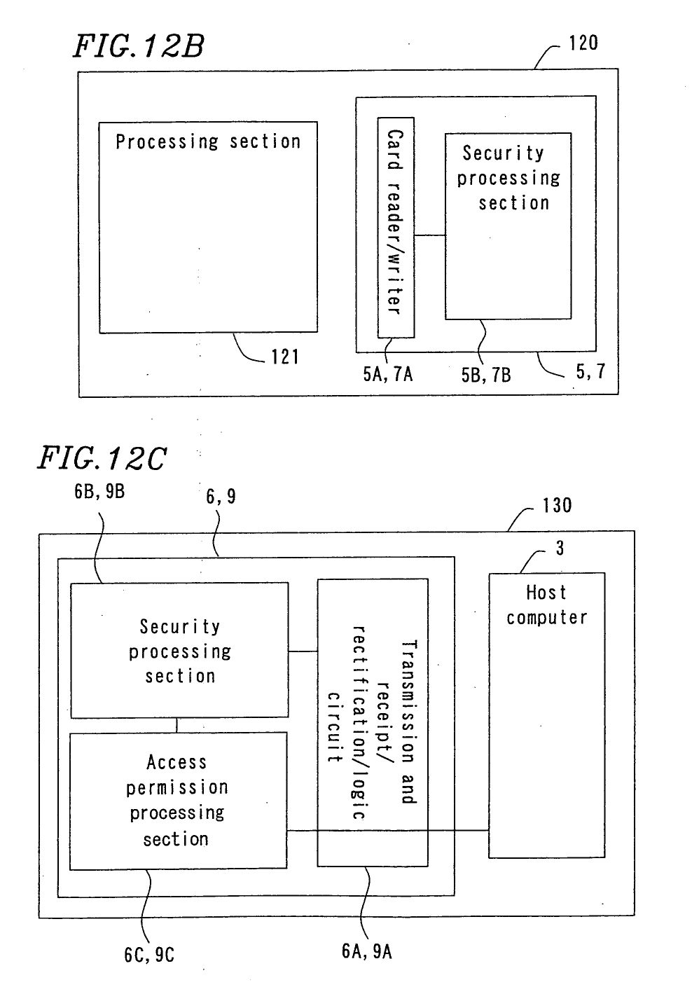

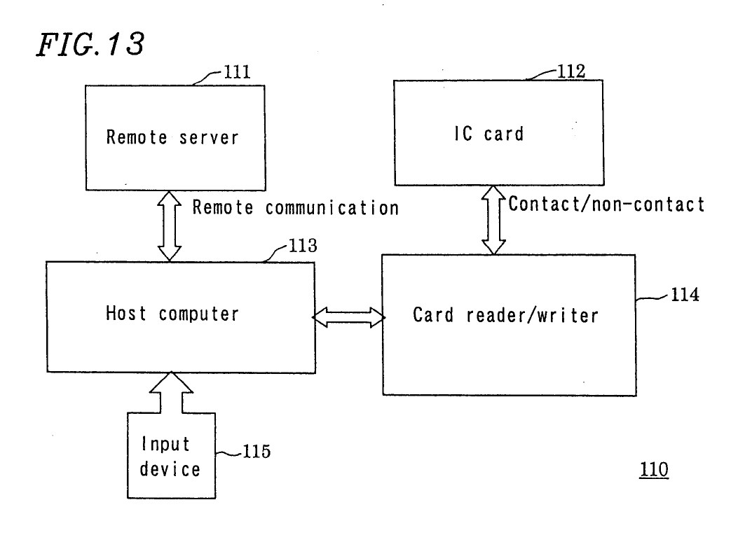

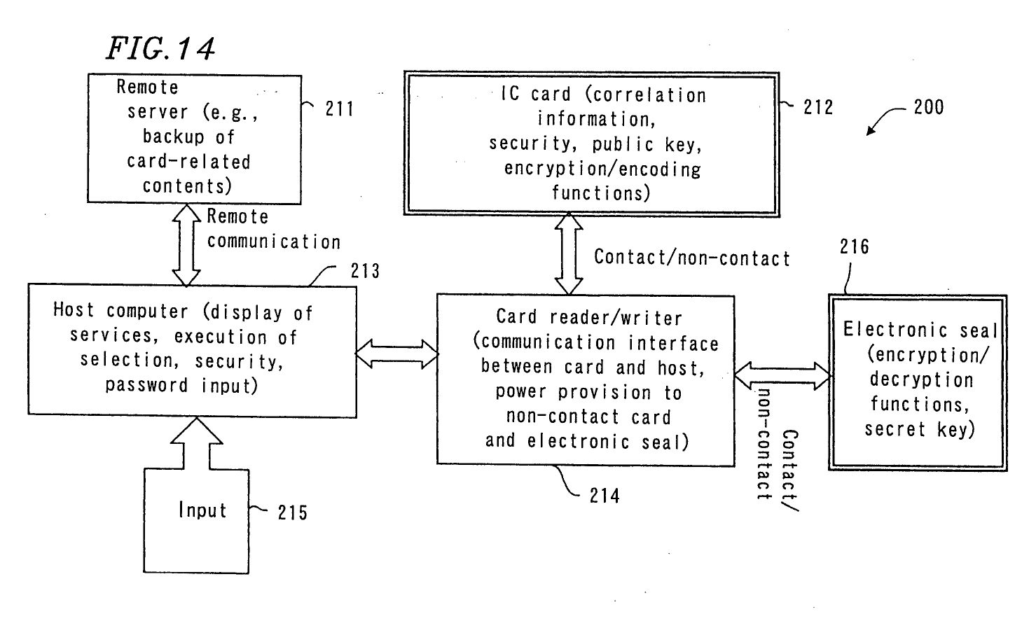

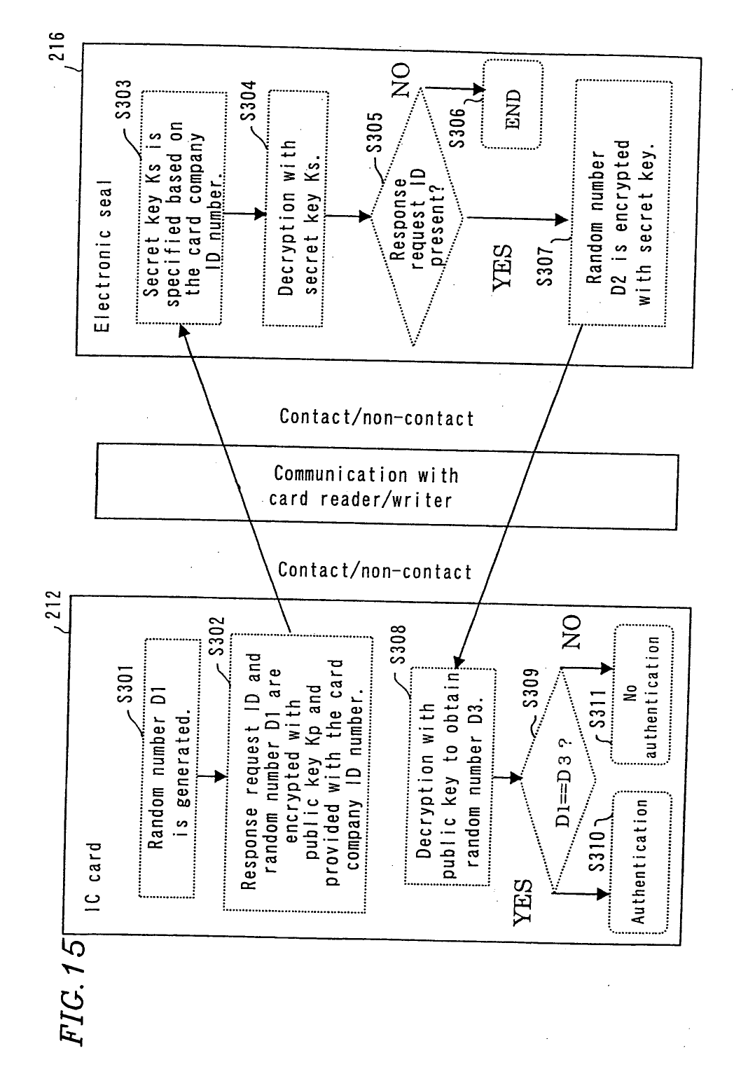

FIG. 12A shows various fields in which the electronic seals 5 and 7 in the first and second examples can be used. Corresponding conventional methods of authentication are indicated in parentheses.

Conventionally, for shopping using a card, authentication is performed by visually confirming the signature. For withdrawal of cash from a bank account using a card, for remote control of home electronics appliances using a cellular phone or the like, for billing of cellular phones or the like using a card, for accessing a personal computer, and for opening an electronic lock, authentication is performed by inputting a password. For managing entering and exiting from a building or a room, for paying for gas and expressway tolls, and for paying for train fares and pay phones, authentication is performed by the card itself. The possessor of the card is determined to be the authentic user of the card. For preventing car theft, authentication is performed by the car key. The possessor of the car key is determined to be the authentic user of the car. At the counter of a municipal office of the like, authentication is performed by a traditional seal. When receiving registered mail, authentication is performed by a traditional seal or signature. Preventing theft of expensive home electronics appliances relies on the precautions of each individual. No authentication is required to permit the use thereof.

In these fields, an electronic seal 5 or 7 according to the present invention can be combined with the conventional method of authentication. Thus, the security level can be significantly improved without putting any burden on the user. Loss of a password is difficult to notice unless damage is caused. Loss of the electronic seal 5 or 7 according to the present invention is easily noticed when stolen, and thus measures against damage can be taken quickly. Mere loss of an electronic seal 5 or 7 is unlikely to cause any damage.

Conventionally, a traditional seal is used for authentication at the counter of a municipal office or the like or for authentication when receiving registered mail. Considering that the digital government will be realized in the future, in which information on each individual is formed into electronic data, and information and services are provided, and also the rights and duties of each individual are managed, using the electronic data, use of an electronic seal 5 or 7 according to the present invention instead of the traditional seal is very effective.

Expensive home electronics appliances, when provided with an authentication function, are prevented from being used after being stolen. Electronic devices such as TVs, refrigerators, video apparatuses, and cameras can be provided with an authentication function such that authentication using the electronic seal 5 or 7 is required before operating these devices. Thus, these devices do not operate without the electronic seal 5 or 7. Such a function is effective in tough neighborhoods.

IC cards such as train passes can be provided with an authentication function using an electronic seal 5 or 7 according to the present invention. Thus, the IC card alone does not function. Therefore, it is expected that more people will report the cards to the police or other authorities when they find them.

FIG. 12B shows a mobile device 120 including the electronic seal 5 or 7 according to the present invention. The mobile device 120 is, for example, a cellular phone. Alternatively, the mobile device 120 may be a car key, a beeper, a PDA (personal digital assistant) or a wrist watch. The mobile device 120 includes the electronic seal 5 or 7 and a processing section 121. The processing section 121 performs necessary functions for the mobile device 120 (for example, when the mobile device 120 is a cellular phone, the processing section 121 performs, for example, a calling function and an electronic mail function). The electronic seal 5 or 7 may be detachably mounted on the cellular phone as the mobile device 120 such that the electronic seal 5 or 7 uses the interface of the cellular phone. In this case, even when the cellular phone is changed to a new model, the electronic seal 5 or 7 can be detached from the old model and attached to the new model. The electronic seal 5 or 7 may be, for example, cylindrical like a battery, prism-shaped, or card-shaped.

The electronic seal 5 or 7 may be used for preventing car theft. The electronic seal 5 or 7 may be used as a car key (or used together with the car key) and the functions of the card 6 or 9 and the host computer 3 may be incorporated into a vehicle start control apparatus in a control section of a car or a vehicle. FIG. 12C shows such a vehicle start control apparatus 130. The vehicle start control apparatus 130 includes the card 6 or 9 and the host computer 3. In this example, any type of memory medium having the function of the card 6 or 9 is usable instead of the card 6 or 9. When the access permission processing section 6C or 9C permits access, the host computer 3, for example, starts the automobile engine.

According to the present invention, a card can be provided with a function of advance authentication with an electronic seal at the stage of production of the card.

According to the present invention, advance authentication is performed with the electronic seal and the card. It is not necessary to provide the electronic seal together with the card to the store clerk, but it is sufficient to provide only the card successfully subjected to the advance authentication. Therefore, the card data can be protected with high security without imposing any additional load on the user.

According to the present invention, the card successfully subjected to the advance authentication can be used with the conventional system which is intended to be used for the card without the advance authentication. Thus, the conventional system can be used without being changed and without being provided with additional elements.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An electronic seal, comprising:
an input/output section for receiving a random number encrypted based on a prescribed key; and
an advance authentication processing section for decrypting the encrypted and received random number based on a secret key related to the prescribed key and then encrypting the decrypted random number based on the secret key,
wherein the input/output section outputs the encrypted random number encrypted based on the secret key.

2. An electronic seal according to claim 1, wherein the advance authentication processing section includes:
a secret key memory section for storing the secret key;
a decryption section for decrypting the encrypted and received random number based on the secret key; and
an encryption section for encrypting the decrypted random number based on the secret key.

3. An electronic seal according to claim 1, further comprising a communication request section for outputting a communication request ID, and the communication request section includes:
a memory section for storing the communication request ID; and
a reading section for reading the communication request ID from the memory section and outputting the communication request ID.

4. An electronic seal according to claim 1, wherein:
the random number encrypted based on the prescribed key is output from a memory medium, and
the input/output section is a reader/writer section for supplying a power to the memory medium.

5. An electronic seal according to claim 1, wherein:
the prescribed key is a public key, and
the secret key forms a key pair with the public key based on one of an RSA cryptosystem and an elliptic curve cryptosystem.

6. An electronic seal according to claim 1, further comprising:
a display section for displaying at least a mode menu and a mode execution result;
a selection key for selecting a prescribed mode from a plurality of modes;
a determination key for determining on the selected mode;
a numeral setting key for setting a numerical value; and
a start key for starting execution of the determined mode.

7. An electronic seal according to claim 6, wherein an external shape of the electronic seal is one of a card-shape, a cylindrical shape, and a prism shape.

8. An electronic seal according to claim 1, further comprising:
an initial setting mode section for receiving key information including the prescribed key and the secret key from an external device only once and retaining the key information; and
a registered seal mode section for outputting the prescribed key.

9. An electronic seal according to claim 1, further comprising a cancel mode section for canceling a result of advance authentication based on an operation of the advance authentication processing section.

10. An electronic seal according to claim 1, further comprising a period setting mode section for outputting information representing an expiration time of a valid time period of use to an external device.

11. An electronic seal according to claim 1, further comprising a times setting mode section for outputting information representing a valid number of times of use to an external device.

12. An electronic seal according to claim 1, further comprising a sum setting mode section for outputting information representing an upper limit of a sum which can be spent in one transaction to an external device.

13. An electronic seal according to claim 6, further comprising a clock mode section for displaying the current time on the display section.

14. A memory medium, comprising:
an advance authentication processing section for generating a random number, encrypting the generated random number based on a prescribed key, decrypting a random number, encrypted based on a secret key related to the prescribed key, based on the prescribed key, and comparing the generated random number and the decrypted random number; and
an input/output section for outputting the random number encrypted based on the prescribed key and receiving the random number encrypted based on the secret key.

15. A memory medium according to claim 14, wherein the advance authentication processing section includes:
a random number generation section for generating the random number;
a prescribed key memory section for storing the prescribed key;
an encryption section for encrypting the generated random number based on the prescribed key;
a decryption section for decrypting the random number, encrypted based on the secret key, based on the prescribed key;
a random number comparison section for comparing the generated random number and the decrypted random number; and
a comparison result memory section for storing a result of comparison.

16. A memory medium according to claim 14, further comprising a start signal generation section for generating a start signal based on a communication request ID, wherein the start signal generation section includes:
a communication request ID memory section for storing the communication request ID; and
a communication request ID comparison section for comparing a communication request ID which is input from an external device and the communication request ID stored in the communication request ID memory section,
wherein the communication request ID comparison section outputs the start signal when the input communication request ID and the communication request ID stored in the communication request ID memory section match each other.

17. A memory medium according to claim 16, wherein the input/output section receives the communication request ID from the external device.

18. A memory medium according to claim 14, wherein:
the prescribed key is a public key, and
the secret key forms a key pair with the public key based on one of an RSA cryptosystem and an elliptic curve cryptosystem.

19. A memory medium according to claim 15, further comprising an access permission processing section for permitting an access when the result of comparison indicates that the generated random number and the decrypted random number match each other, and for prohibiting an access when the result of comparison indicates that the generated random number and the decrypted random number do not match each other.

20. A memory medium according to claim 19, wherein, when the result of comparison indicates that the generated random number and the decrypted random number match each other, the access permission processing section permits an access and resets the result of comparison stored in the comparison result memory section.

21. A memory medium according to claim 14, further comprising an initial setting mode section for setting a prescribed key which is input from an external device.

22. A memory medium according to claim 21, further comprising a prescribed memory section, wherein the initial setting mode section outputs the input prescribed key to the prescribed key memory section.

23. A memory medium according to claim 14, further comprising a cancel mode section for canceling a result of advance authentication based on an operation of the advance authentication processing section.

24. A memory medium according to claim 14, further comprising a period setting mode section for prohibiting an access after an expiration time of a valid time period of use has passed.

25. A memory medium according to claim 14, further comprising a times setting mode section for prohibiting an access when a number of times that the memory medium has been used exceeds a valid number of times of use.

26. A memory medium according to claim 14, further comprising a sum setting mode section for prohibiting an access when a sum to be used exceeds an upper limit of a sum which can be spent in one transaction.

27. An advance authentication system, comprising a memory medium and an electronic seal,
wherein the memory medium includes:
a first advance authentication processing section for generating a random number and encrypting the generated random number based on a prescribed key, and
a first input/output section for outputting the random number encrypted based on the prescribed key, and
wherein the electronic seal includes:
a second input/output section for receiving the random number encrypted based on the prescribed key, and
a second advance authentication processing section for decrypting the encrypted and received random number based on a secret key related to the prescribed key and then encrypting the decrypted random number based on the secret key,
wherein:
the second input/output section outputs the random number encrypted based on the secret key,
the first input/output section receives the random number encrypted based on the secret key,
the first advance authentication processing section decrypts the random number, encrypted based on the secret key, based on the prescribed key, and compares the generated random number and the random number decrypted based on the prescribed key, and
the memory medium and the electronic seal perform mutual data communication to perform advance authentication processing.

28. An advance authentication system according to claim 27, wherein the memory medium is one of an IC card and a memory card.

29. A mobile device including an electronic seal, wherein the electronic seal includes:
an input/output section for receiving a random number encrypted based on a prescribed key; and
an advance authentication processing section for decrypting the encrypted and received random number based on a secret key related to the prescribed key and then encrypting the decrypted random number based on the secret key,
wherein the input/output section outputs the encrypted random number encrypted based on the secret key.

30. A mobile device according to claim 29, wherein the mobile device is a cellular phone detachably accommodating the electronic seal.

31. A vehicle start control apparatus including a memory medium, wherein the memory medium includes:
an advance authentication processing section for generating a random number, encrypting the generated random number based on a prescribed key, decrypting a random number, encrypted based on a secret key related to the prescribed key, based on the prescribed key, and comparing the generated random number and the decrypted random number; and
an input/output section for outputting the random number encrypted based on the prescribed key and receiving the random number encrypted based on the secret key.
